(19) United States
(12) Patent Application Publication
(10) Pub. No.: US 2020/0404222 A1
(43) Pub. Date: Dec. 24, 2020

(54) TRACKING ASSISTANCE DEVICE, TRACKING ASSISTANCE SYSTEM AND TRACKING ASSISTANCE METHOD

(71) Applicant: PANASONIC INTELLECTUAL PROPERTY MANAGEMENT CO., LTD., Osaka (JP)

(72) Inventors: Sonoko HIRASAWA, Kanagawa (JP); Takeshi FUJIMATSU, Kanagawa (JP)

(73) Assignee: PANASONIC INTELLECTUAL PROPERTY MANAGEMENT CO., LTD., Osaka (JP)

(21) Appl. No.: 16/324,813

(22) PCT Filed: May 11, 2017
(86) PCT No.: PCT/JP2017/017796

§ 371 Date: Feb. 11, 2019

(30) Foreign Application Priority Data
Aug. 24, 2016 (JP) 2016-163946

(51) Int. Cl. H04N 7/18; G06T 7/292; H04N 5/262

(52) U.S. Cl. CPC H04N 7/188; G06T 7/292; H04N 5/2628; G06T 2207/30232; G06T 2207/10016; G06T 2207/30196; H04N 7/181

(57) ABSTRACT

The present application enables improved tracking assistance of an object and includes a link score calculator that calculates a link score from tracking information based on an image captured by cameras, a tracking target setter that sets the object to be tracked in accordance with designation by a monitor, a confirmation image presenter that displays an image of an object having a highest evaluation value as a confirmation image, a thumbnail generator that generates a thumbnail of each object, a candidate image presenter that displays a thumbnail of each object having a lower evaluation value than an object of an erroneous confirmation image and allows the monitor to select a candidate image corresponding to the object to be tracked, and a tracking information corrector that corrects inter-camera tracking information such that the object of the selected candidate image is associated with the object to be tracked.

### TECHNICAL FIELD

The present disclosure relates to a tracking assistance device, a tracking assistance system, and a tracking assistance method, which each displays on a display device, a captured image from each of a plurality of cameras, which is accumulated in an image accumulation unit and assists a monitoring person's work of tracking a moving object to be tracked.

### BACKGROUND ART

A monitoring system in which a plurality of cameras are installed in a monitoring area and a monitoring screen for displaying a captured image from each of the plurality of cameras is displayed on a monitor so as to be monitored by a monitoring person has been widely spread. In such a monitoring system, captured images from the cameras are accumulated in a recorder, so a monitoring person can check what types of actions a person performs a problematic action such as shoplifting in the monitoring area.

In this way, in a case where a monitoring person tracks a person while viewing the monitoring screen, as the person moves in the monitoring area, the cameras which capture the image of the person are switched one by one, so it is required to sequentially check the captured image from each of the cameras.

Thus, a technique of providing an image display window for displaying the captured image from each camera on the display screen of the monitor, displaying the image of the person designated by the monitoring person as the tracking target in the image display window, and displaying the traveling route of the person on the display screen of the monitor has been known (see PTL 1). In this technique, since the traveling route is displayed, it is possible to relatively easily perform a tracking work while changing cameras one by one, thereby reducing to a certain extent the burden on the monitoring person who performs the tracking work.

### CITATION LIST

### Patent Literature

PTL 1: Japanese Patent No. 4759988 B2

### SUMMARY OF THE INVENTION

A device performs a process of tracking a person using an image recognition technique in order to sequentially display a captured image from each camera related to a person designated as a tracking target on the display screen of a monitor, but in the tracking process, there may be an error in the tracking result, such as the tracking of the person designated as the tracking target fails, and the person is replaced with another person. When there is an error in the tracking result in this way, the error interferes with the work of tracking the person, so a work for checking whether there is no error in the tracking result is needed. Particularly, in a large-scale monitoring system covering a wide monitoring area, a large number of monitoring cameras such as dozens or hundreds of surveillance cameras are used, it is extremely troublesome to checking the tracking result. Therefore, a technique capable of efficiently checking the tracking result is desired.

However, according to the technique disclosed in PTL 1, since a person set as a tracking target is not always shown in any image display window of the screen, that is, the image of the person set as a tracking target is not displayed on the screen without omission throughout the entire moving path in the monitoring area, it is not possible to efficiently check the tracking result for a person set as the tracking target, and especially there is a problem that checking is complicated, as the number of cameras increases. In addition, in a case where there is an error in the tracking result for a person, there is a problem that it is impossible to effectively deal with the problem in the related art, and it is impossible to properly perform an assistance process for reducing the burden on the monitoring person.

In particular, in a case of tracking a person in a captured image of a camera, first, in order to designate a person to be tracked, it is necessary to perform a work of searching for an image capturing the person to be tracked. In a case where there is an error in the tracking result of a person, it is necessary to perform the work of searching for an image capturing the person who is a tracking target during the tracking period. However, as the number of cameras increases, a work for finding a corresponding image becomes very troublesome, and a technique is desired that enables a monitoring person to efficiently perform the work for finding an image capturing the person who is a tracking target.

An object of the present disclosure is to provide a tracking assistance device, a tracking assistance system, and a tracking assistance method, in which it is possible to efficiently check whether there is an error in the tracking result for the moving object set as the tracking target and to correct tracking information with a simple operation in a case where there is an error in the tracking result for the moving object, and in which in particular, a monitoring person can efficiently perform the work for finding an image capturing the moving object which is a tracking target.

A tracking assistance device of the present disclosure is a tracking assistance device that displays on a display device, a captured image from each of a plurality of cameras, which is accumulated in image accumulation means, and assists a monitoring person's work of tracking a moving object to be tracked, including an evaluation value calculator that calculates an evaluation value representing a level of identity between moving objects, based on tracking information of the moving objects detected from the captured image from each of the plurality of cameras; a tracking target setter that displays a plurality of the captured images on the display device, and in response to an operation input by the monitoring person designating a moving object to be tracked by using the captured images, sets the designated moving object as a tracking target; a confirmation image presenter that sequentially specifies a camera to take over imaging of the moving object set as the tracking target, by repeating a process of selecting a moving object with a highest evaluation value, from among moving objects detected from captured images of the cameras which are in a cooperation relationship, and displays, on the display device, a tracking target confirmation screen in which a captured image of the moving object with the highest evaluation value is displayed as a confirmation image, for each of the cameras; a thumbnail generator that cuts out areas of the moving objects from the captured images and generates a thumbnail image of each of the moving objects; a candidate image presenter that in a case where there is an error in the confirmation image displayed on the tracking target confirmation screen, displays on the display device, a candidate selection screen in which the thumbnail images of respective moving objects having evaluation values lower than the moving object corresponding to the confirmation image are listed and displayed as candidate images, and allows the monitoring person to select the candidate image corresponding to the moving object designated as the tracking target; and a tracking information corrector that corrects the inter-camera tracking information such that a moving object corresponding to the candidate image selected on the candidate selection screen is associated with the moving object set as the tracking target.

A tracking assistance system of the present disclosure is a tracking assistance system that displays on a display device, a captured image from each of a plurality of cameras, which is accumulated in image accumulation means, and assists a monitoring person's work of tracking a moving object to be tracked, including the camera that captures an image of a monitoring area; the display device that displays the captured image from each of the cameras; and a plurality of information processing apparatuses, in which any one of the plurality of information processing apparatuses includes an evaluation value calculator that calculates an evaluation value representing a level of identity between moving objects, based on tracking information of the moving objects detected from the captured image from each of the plurality of cameras; a tracking target setter that displays a plurality of the captured images on the display device, and in response to an operation input by the monitoring person designating a moving object to be tracked by using the captured images, sets the designated moving object as a tracking target; a confirmation image presenter that sequentially specifies a camera to take over imaging of the moving object set as the tracking target, by repeating a process of selecting a moving object with a highest evaluation value, from among moving objects detected from captured images of the cameras which are in a cooperation relationship, and displays, on the display device, a tracking target confirmation screen in which a captured image of the moving object with the highest evaluation value is displayed as a confirmation image, for each of the cameras; a thumbnail generator that cuts out areas of the moving objects from the captured images and generates a thumbnail image of each of the moving objects; a candidate image presenter that in a case where there is an error in the confirmation image displayed on the tracking target confirmation screen, displays on the display device, a candidate selection screen in which the thumbnail images of respective moving objects having evaluation values lower than the moving object corresponding to the confirmation image are listed and displayed as candidate images, and allows the monitoring person to select the candidate image corresponding to the moving object designated as the tracking target; and a tracking information corrector that corrects the inter-camera tracking information such that a moving object corresponding to the candidate image selected on the candidate selection screen is associated with the moving object set as the tracking target.

A tracking assistance method of the present disclosure is a tracking assistance method causing an information processing apparatus to perform a process of displaying on a display device, a captured image from each of a plurality of cameras, which is accumulated in image accumulation means, and assisting a monitoring person's work of tracking a moving object to be tracked, including calculating an evaluation value representing a level of identity between moving objects, based on tracking information of the moving objects detected from the captured image from each of the plurality of cameras; displaying a plurality of the captured images on the display device, and in response to an operation input by the monitoring person designating a moving object to be tracked by using the captured images, setting the designated moving object as a tracking target; sequentially specifying a camera to take over imaging of the moving object set as the tracking target, by repeating a process of selecting a moving object with a highest evaluation value, from among moving objects detected from captured images of the cameras which are in a cooperation relationship, and displaying, on the display device, a tracking target confirmation screen in which a captured image of the moving object with the highest evaluation value is displayed as a confirmation image, for each of the cameras; cutting out an area of the moving object from the captured image and generating a thumbnail image of each of the moving objects; displaying in a case where there is an error in the confirmation image displayed on the tracking target confirmation screen, on the display device, a candidate selection screen in which the thumbnail images of respective moving objects having evaluation values lower than the moving object corresponding to the confirmation image are listed and displayed as candidate images, and allowing the monitoring person to select the candidate image corresponding to the moving object designated as the tracking target; and correcting the inter-camera tracking information such that a moving object corresponding to the candidate image selected on the candidate selection screen is associated with the moving object set as the tracking target.

According to the present disclosure, since the image captured by a camera having the highest possibility of showing the moving object set as the tracking target is refined and displayed, it is possible to efficiently check the tracking result for a moving object. In a case where there is an error in the confirmation image displayed in the tracking target confirmation screen, that is, there is an error in the tracking result for the moving object, a candidate image that is a substitute for the confirmation image is displayed, so tracking information is corrected simply by the monitoring person selecting the candidate image, and thus tracking information can be corrected with a simple operation. In particular, since the thumbnail image of each moving object is displayed on the candidate selection screen, it is easy to identify the moving object on the image, so it is possible to eliminate the problem of missing the moving object set as the tracking target and efficiently perform the work for finding the image of the moving object to be tracked.

### BRIEF DESCRIPTION OF DRAWINGS

FIG. 1 is an overall configuration diagram of a tracking assistance system according to a present exemplary embodiment.

FIG. 2 is a plan view showing an installation situation of camera 1 in a store.

FIG. 3 is a functional block diagram illustrating a schematic configuration of PC 3.

FIG. 4 is an explanatory diagram illustrating a transition status of a screen displayed on monitor 7.

FIG. 5 is a flowchart showing a procedure of a process performed in each unit of PC 3 in response to an operation of a monitoring person performed on each screen.

FIG. 6 is an explanatory diagram showing a person search screen in an initial designation state in a person-specific list mode.

FIG. 7 is an explanatory diagram showing a person search screen in the initial designation state in a camera-specific list mode.

FIG. 8 is an explanatory diagram showing a main part of the person search screen in the camera-specific list mode.

FIG. 9 is an explanatory diagram illustrating a timeline screen in a confirmation state.

FIG. 10A is an explanatory diagram illustrating a main part of the timeline screen in the confirmation state.

FIG. 10B is an explanatory diagram illustrating the main part of the timeline screen in the confirmation state.

FIG. 11 is an explanatory diagram illustrating a timeline screen in a continuous playback state.

FIG. 12 is an explanatory diagram illustrating a timeline screen in a candidate display state.

FIG. 13 is an explanatory diagram illustrating a candidate image displayed on the timeline screen in the candidate display state.

FIG. 14 is an explanatory diagram illustrating the candidate image displayed on the timeline screen in the candidate display state.

FIG. 15 is an explanatory diagram showing a person search screen in the additional designation state in the person-specific list mode.

FIG. 16 is an explanatory diagram showing a person search screen in the additional designation state in the camera-specific list mode.

### DESCRIPTION OF EMBODIMENTS

A first aspect of the present invention made in order to solve the above problems is a tracking assistance device that displays on a display device, a captured image from each of a plurality of cameras, which is accumulated in image accumulation means, and assists a monitoring person's work of tracking a moving object to be tracked, including an evaluation value calculator that calculates an evaluation value representing a level of identity between moving objects, based on tracking information of the moving objects detected from the captured image from each of the plurality of cameras; a tracking target setter that displays a plurality of the captured images on the display device, and in response to an operation input by the monitoring person designating a moving object to be tracked by using the captured images, sets the designated moving object as a tracking target; a confirmation image presenter that sequentially specifies a camera to take over imaging of the moving object set as the tracking target, by repeating a process of selecting a moving object with a highest evaluation value, from among moving objects detected from captured images of the cameras which are in a cooperation relationship, and displays, on the display device, a tracking target confirmation screen in which a captured image of the moving object with the highest evaluation value is displayed as a confirmation image, for each of the cameras; a thumbnail generator that cuts out areas of the moving objects from the captured images and generates a thumbnail image of each of the moving objects; a candidate image presenter that in a case where there is an error in the confirmation image displayed on the tracking target confirmation screen, displays on the display device, a candidate selection screen in which the thumbnail images of respective moving objects having evaluation values lower than the moving object corresponding to the confirmation image are listed and displayed as candidate images, and allows the monitoring person to select the candidate image corresponding to the moving object designated as the tracking target; and a tracking information corrector that corrects the inter-camera tracking information such that a moving object corresponding to the candidate image selected on the candidate selection screen is associated with the moving object set as the tracking target.

According to this, since the image captured by a camera having the highest possibility that the moving object set as the tracking target is captured is refined and displayed, it is possible to efficiently check the tracking result for a moving object. In a case where there is an error in the confirmation image displayed in the tracking target confirmation screen, that is, there is an error in the tracking result for the moving object, a candidate image that is a substitute for the confirmation image is displayed, so tracking information is corrected simply by the monitoring person selecting the candidate image, and thus tracking information can be corrected with a simple operation. In particular, since the thumbnail image of each moving object is displayed on the candidate selection screen, it is easy to identify the moving object on the image, so it is possible to eliminate the problem of missing the moving object set as the tracking target and efficiently perform the work for finding the image of the moving object to be tracked.

A second aspect of the present invention is a tracking assistance device that displays on a display device, a captured image from each of a plurality of cameras, which is accumulated in image accumulation means, and assists a monitoring person's work of tracking a moving object to be tracked, an evaluation value calculator that calculates an evaluation value representing a level of identity between moving objects, based on tracking information of the moving objects detected from the captured image from each of the plurality of cameras; a thumbnail generator that cuts out areas of the moving objects from the captured images and generates a thumbnail image of each of the moving objects; a tracking target setter that displays on the display device, a tracking target search screen in which thumbnail images of respective moving objects are displayed as a list, and in response to an operation input by a monitoring person designating a moving object to be tracked by selecting the thumbnail image, sets the designated moving object as a tracking target; a confirmation image presenter that sequentially specifies a camera to take over imaging of the moving object set as the tracking target, by repeating a process of selecting a moving object with a highest evaluation value, from among moving objects detected from captured images of the cameras which are in a cooperation relationship, and displays, on the display device, a tracking target confirmation screen in which a captured image of the moving object with the highest evaluation value is displayed as a confirmation image, for each of the cameras; a candidate image presenter that in a case where there is an error in the confirmation image displayed on the tracking target confirmation screen, displays on the display device, a candidate selection screen in which candidate images of respective moving objects having evaluation values lower than the moving object corresponding to the confirmation image are displayed, and allows the monitoring person to select the candidate image corresponding to the moving object designated as the tracking target; and a tracking information corrector that corrects the inter-camera tracking information such that a moving object corresponding to the candidate image selected on the candidate selection screen is associated with the moving object set as the tracking target.

According to this, since the image captured by camera 1 having the highest possibility that the moving object set as the tracking target is captured is refined and displayed, it is possible to efficiently check the tracking result for a moving object. In a case where there is an error in the confirmation image displayed in the tracking target confirmation screen, that is, there is an error in the tracking result for the moving object, a candidate image that is a substitute for the confirmation image is displayed, so tracking information is corrected simply by the monitoring person selecting the candidate image, and thus tracking information can be corrected with a simple operation. In particular, since the thumbnail image of each moving object is displayed on the tracking target search screen, it is easy to identify the moving object on the image, so it is possible to eliminate the problem of missing the moving object to be tracked and efficiently perform the work for finding the image of the moving object to be tracked.

Further, a third invention is configured such that the tracking target setter arranges the thumbnail images in time series, and displays the thumbnail images as a list, on the tracking target search screen.

According to this, it is possible to more efficiently perform the work for finding the image of the moving object to be tracked.

Further, a fourth invention is configured to further include an image player that thins out and plays back the selected thumbnail image, in response to an operation input of a monitoring person selecting the thumbnail image.

According to this, it is possible to confirm the thumbnail image over the entire tracking period of the moving object corresponding to the thumbnail image, in a short time.

Further, a fifth invention is configured to further include an additional tracking target setter that in a case where there is no candidate image corresponding to the moving object designated as the tracking target, among the candidate images displayed on the candidate selection screen, displays on the display device, the tracking target search screen in which thumbnail images of respective moving objects are displayed as a list, and in response to an operation input of the monitoring person designating a moving object to be tracked by selection of the thumbnail image, sets the designated moving object as an additional tracking target, in which the tracking information corrector corrects the inter-camera tracking information such that the moving object which is set as the additional tracking target by the additional tracking target setter is associated with the moving object which is set as the tracking target by the tracking target setter.

According to this, even in a case where there is no candidate image corresponding to the moving object designated as the tracking target among the candidate images displayed on the candidate selection screen, tracking information corresponding to a confirmation image with an error is corrected by the monitoring person designating the moving object to be tracked, which makes it possible to avoid the lack of tracking information. In particular, since the thumbnail images are displayed on the tracking target search screen, it is possible to efficiently find the moving object set as a tracking target.

Further, a sixth invention is configured such that the tracking target setter displays either a moving object-specific image list for displaying the thumbnail images for respective moving objects as a list, or a camera-specific image list for displaying the captured images from respective cameras as a list, on the tracking target search screen, in response to the operation input of a monitoring person selecting a display mode.

According to this, since it is possible to switch between the camera-specific image list and the moving object-specific image list according to the needs of the user, convenience of the user is improved.

A seventh aspect of the present invention further includes a feature refiner that refines a moving object to be a candidate, based on the feature information of the moving object to be tracked, and the candidate image presenter displays the thumbnail image of the moving object, which is narrowed down by the feature refiner, on a candidate selection screen.

According to this, since the number of thumbnail images displayed on the candidate selection screen is reduced, it is possible to efficiently perform the work of searching for the moving object set as the tracking target.

An eighth aspect of the present invention further includes a feature refiner that refines a moving object to be searched, based on the feature information of the moving object to be tracked, and the tracking target setter displays the thumbnail image of the moving object, which is narrowed down by the feature refiner, on a tracking target search screen.

According to this, since the number of thumbnail images displayed on the tracking target search screen is reduced, it is possible to efficiently perform the work of searching for the moving object to be tracked.

A ninth invention is a tracking assistance system that displays on a display device, a captured image from each of a plurality of cameras, which is accumulated in image accumulation means, and assists a monitoring person's work of tracking a moving object to be tracked, including the camera that captures an image of a monitoring area; the display device that displays the captured image from each of the cameras; and a plurality of information processing apparatuses, in which each of the plurality of information processing apparatuses includes an evaluation value calculator that calculates an evaluation value representing a level of identity between moving objects, based on tracking information of the moving objects detected from the captured image from each of the plurality of cameras; a tracking target setter that displays a plurality of the captured images on the display device, and in response to an operation input by the monitoring person designating a moving object to be tracked by using the captured images, sets the designated moving object as a tracking target; a confirmation image presenter that sequentially specifies a camera to take over imaging of the moving object set as the tracking target, by repeating a process of selecting a moving object with a highest evaluation value, from among moving objects detected from captured images of the cameras which are in a cooperation relationship, and displays, on the display device, a tracking target confirmation screen in which a captured image of the moving object with the highest evaluation value is displayed as a confirmation image, for each of the cameras; a thumbnail generator that cuts out areas of the moving objects from the captured images and generates a thumbnail image of each of the moving objects; a candidate image presenter that in a case where there is an error in the confirmation image displayed on the tracking target confirmation screen, displays on the display device, a candidate selection screen in which the thumbnail images of respective moving objects having evaluation values lower than the moving object corresponding to the confirmation image are listed and displayed as a candidate image, and allows the monitoring person to select the candidate image corresponding to the moving object designated as the tracking target; and a tracking information corrector that corrects the inter-camera tracking information such that a moving object corresponding to the candidate image selected on the candidate selection screen is associated with the moving object set as the tracking target.

According to this, similar to the first aspect, it is possible to efficiently check whether there is an error in the tracking result for the moving object set as the tracking target and to correct tracking information with a simple operation in a case where there is an error in the tracking result for the moving object, and in particular, a monitoring person can efficiently perform the work for finding an image capturing the moving object which is the tracking target, on the candidate selection screen.

A tenth invention is a tracking assistance system that displays on a display device, a captured image from each of a plurality of cameras, which is accumulated in image accumulation means, and assists a monitoring person's work of tracking a moving object to be tracked, comprising: the camera that captures an image of a monitoring area; the display device that displays the captured image from each of the cameras; and a plurality of information processing apparatuses, in which any one of the plurality of information processing apparatus includes an evaluation value calculator that calculates an evaluation value representing a level of identity between moving objects, based on tracking information of the moving objects detected from the captured image from each of the plurality of cameras; a thumbnail generator that cuts out areas of the moving objects from the captured images and generates a thumbnail image of each of the moving objects; a tracking target setter that displays on the display device, a tracking target search screen in which thumbnail images of respective moving objects are displayed as a list, and in response to an operation input by a monitoring person designating a moving object to be tracked by selecting the thumbnail image, sets the designated moving object as a tracking target; a confirmation image presenter that sequentially specifies a camera to take over imaging of the moving object set as the tracking target, by repeating a process of selecting a moving object with a highest evaluation value, from among moving objects detected from captured images of the cameras which are in a cooperation relationship, and displays, on the display device, a tracking target confirmation screen in which a captured image of the moving object with the highest evaluation value is displayed as a confirmation image, for each of the cameras; a candidate image presenter that in a case where there is an error in the confirmation image displayed on the tracking target confirmation screen, displays on the display device, a candidate selection screen in which candidate images of respective moving objects having evaluation values lower than the moving object corresponding to the confirmation image are displayed, and allows the monitoring person to select the candidate image corresponding to the moving object designated as the tracking target; and a tracking information corrector that corrects the inter-camera tracking information such that a moving object corresponding to the candidate image selected on the candidate selection screen is associated with the moving object set as the tracking target.

According to this, similar to the second aspect, it is possible to efficiently check whether there is an error in the tracking result for the moving object set as the tracking target, and to correct tracking information with a simple operation in a case where there is an error in the tracking result for the moving object, and in particular, the monitoring person can efficiently perform the work for finding an image capturing the moving object which is the tracking target, on the tracking target search screen.

An eleventh invention is a tracking assistance method causing an information processing apparatus to perform a process of displaying on a display device, a captured image from each of a plurality of cameras, which is accumulated in image accumulation means, and assisting a monitoring person's work of tracking a moving object to be tracked, including calculating an evaluation value representing a level of identity between moving objects, based on tracking information of the moving objects detected from the captured image from each of the plurality of cameras; displaying a plurality of the captured images on the display device, and in response to an operation input by the monitoring person designating a moving object to be tracked by using the captured images, setting the designated moving object as a tracking target; sequentially specifying a camera to take over imaging of the moving object set as the tracking target, by repeating a process of selecting a moving object with a highest evaluation value, from among moving objects detected from captured images of the cameras which are in a cooperation relationship, and displaying, on the display device, a tracking target confirmation screen in which a captured image of the moving object with the highest evaluation value is displayed as a confirmation image, for each of the cameras; cutting out an area of the moving object from the captured image and generating a thumbnail image of each of the moving objects; displaying in a case where there is an error in the confirmation image displayed on the tracking target confirmation screen, on the display device, a candidate selection screen in which the thumbnail images of respective moving objects having evaluation values lower than the moving object corresponding to the confirmation image are listed and displayed as candidate images, and allowing the monitoring person to select the candidate image corresponding to the moving object designated as the tracking target; and correcting the inter-camera tracking information such that a moving object corresponding to the candidate image selected on the candidate selection screen is associated with the moving object set as the tracking target.

According to this, similar to the first aspect, it is possible to efficiently check whether there is an error in the tracking result for the moving object set as the tracking target and to correct tracking information with a simple operation in a case where there is an error in the tracking result for the moving object, and in particular, a monitoring person can efficiently perform the work for finding an image capturing the moving object which is the tracking target, on the candidate selection screen.

A twelfth invention is a tracking assistance method causing an information processing apparatus to perform a process of displaying on a display device, a captured image from each of a plurality of cameras, which is accumulated in image accumulation means, and assisting a monitoring person's work of tracking a moving object to be tracked, including calculating an evaluation value representing a level of identity between moving objects, based on tracking information of the moving objects detected from the captured image from each of the plurality of cameras; cutting out an area of the moving object from the captured image and generating a thumbnail image of each of the moving objects; displaying on the display device, a tracking target search screen in which thumbnail images of respective moving objects are displayed as a list, and in response to an operation input by a monitoring person designating a moving object to be tracked by selecting the thumbnail image, sets the designated moving object as a tracking target; sequentially specifying a camera to take over imaging of the moving object set as the tracking target, by repeating a process of selecting a moving object with a highest evaluation value, from among moving objects detected from captured images of the cameras which are in a cooperation relationship, and displaying, on the display device, a tracking target confirmation screen in which a captured image of the moving object with the highest evaluation value is displayed as a confirmation image, for each of the cameras; displaying in a case where there is an error in the confirmation image displayed on the tracking target confirmation screen, on the display device, a candidate selection screen in which the thumbnail images of respective moving objects having evaluation values lower than the moving object corresponding to the confirmation image are listed and displayed as candidate images, and allowing the monitoring person to select the candidate image corresponding to the moving object designated as the tracking target; and correcting inter-camera tracking information such that a moving object corresponding to the candidate image selected on the candidate selection screen is associated with the moving object set as the tracking target.

According to this, similar to the second aspect, it is possible to efficiently check whether there is an error in the tracking result for the moving object set as the tracking target, and to correct tracking information with a simple operation in a case where there is an error in the tracking result for the moving object, and in particular, the monitoring person can efficiently perform the work for finding an image capturing the moving object which is the tracking target, on the tracking target search screen.

Hereinafter, embodiments will be described with reference to the drawings. In the description of the present exemplary embodiment, two separate Japanese terms having the same meaning of tracking are used. Although they are merely used for convenience of explanation, and they are distinguished depending on usage related to a monitoring person's behavior and usage related to the processes performed on devices.

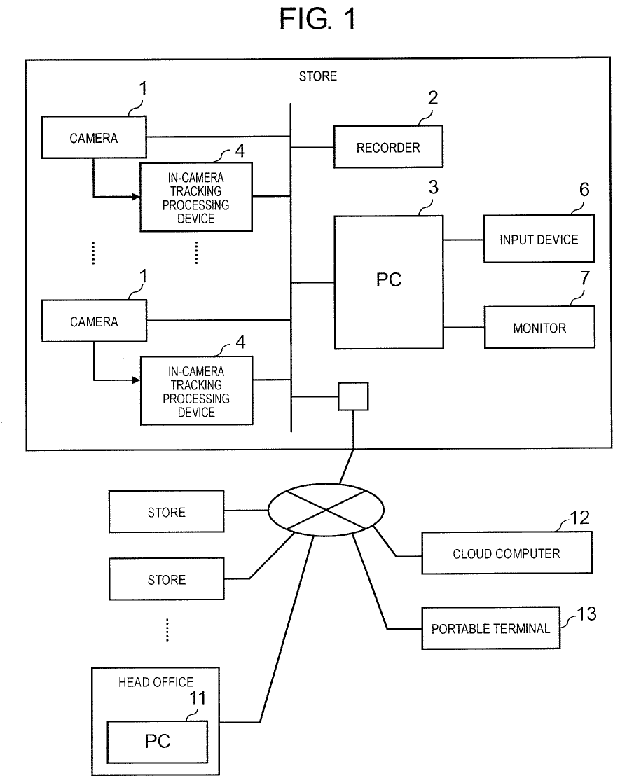

FIG. 1 is an overall configuration diagram of a tracking assistance system according to a present exemplary embodiment.

The tracking assistance system is constructed for a retail store such as a supermarket and a home center, and includes camera 1, recorder (image accumulation means) 2, PC (tracking assistance device) 3, and in-camera tracking processing device 4.

Camera 1 is installed at an appropriate place in the store, and the inside of the store (monitoring area) is imaged by camera 1, and the captured images of the interior of the store captured by camera 1 are recorded in recorder 2.

PC 3 is connected with input device 6 such as a mouse with which a monitoring person (user) performs various input operations and monitor (display device) 7 that displays a monitoring screen. PC 3 is installed in a security room or the like of a store, and a monitoring person (security guard) can view the current captured images of the interior of the store output from camera 1 in real time and the past captured images of the interior of the store recorded in recorder 2, on a monitor screen displayed on monitor 7.

A monitor not shown in FIG. 1 is also connected to PC 11 provided in the head office, and displays the current captured images of the interior of the store output from camera 1 and the past captured images of the interior of the store recorded in recorder 2, which allows a user at the head office to check the situation in the store.

In-camera tracking processing device 4 performs a process of tracking a person (moving object) detected from the captured image from camera 1 and generating in-camera tracking information for each person. For the in-camera tracking process, known image recognition techniques (such as a person detection technique and a person tracking technique) may be used. Here, as the in-camera tracking information, the detection time of the person (the imaging time of the frame), the detection position of the person, the movement speed of the person, the color information of the person image, and the like are generated for each detected person.

In the present exemplary embodiment, in-camera tracking processing device 4 is configured to constantly perform an in-camera tracking process independently of PC 3, but may perform the tracking process in response to an instruction from PC 3. It is desirable that in-camera tracking processing device 4 performs the tracking process for all people detected from the captured images, but the tracking process may be performed by focusing on the person designated as the tracking target and a person highly relevant to the person.

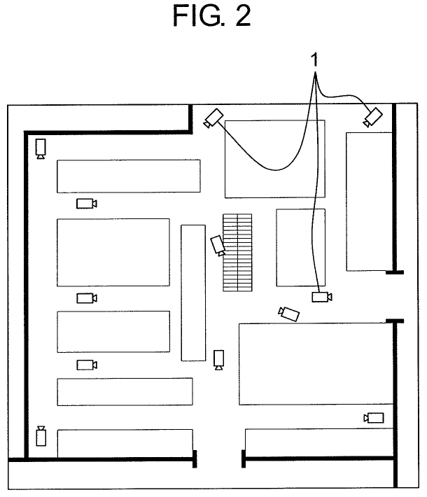

Next, the installation situation of camera 1 in the store will be described. FIG. 2 is a plan view showing the installation situation of camera 1 in the store.

In the store (monitoring area), a passage is provided between product display spaces, and a plurality of cameras 1 are installed so as to mainly image the passage.

When a person moves in a passage in the store, the person is imaged by one or more of cameras 1, and in accordance with the movement of the person, imaging of the person is handed over to next camera 1. At this time, a camera taking over the imaging of a person is limited by the form of the passage in the store and the imaging area of camera 1, and in the present exemplary embodiment, the camera taking over the imaging of a person is referred to as a camera having a cooperation relationship. Information on the cooperation relationship of the camera is set in advance, and is held in PC 3 as camera cooperation information. The information on the cooperation relationship of the cameras is prepared for a change in the number of cameras 1 and the installation locations thereof, or the like, the installation information of each camera 1 may be individually acquired by PC 3 at the time of starting the system, and the information on the cooperation relationship of the respective cameras may be updated.

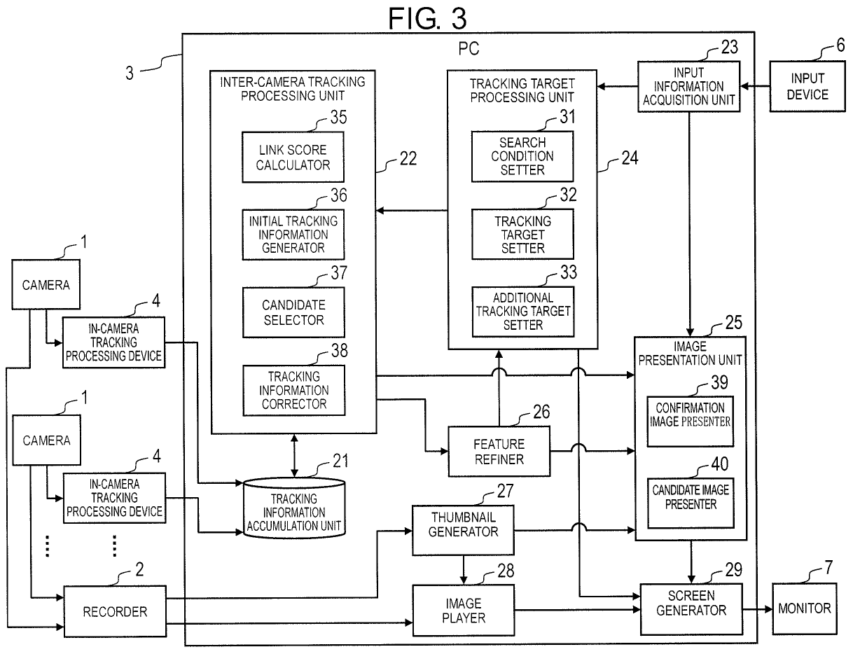

Next, a schematic configuration of PC 3 will be described. FIG. 3 is a functional block diagram illustrating the schematic configuration of PC 3.

PC 3 includes tracking information accumulation unit 21, inter-camera tracking processing unit 22, input information acquisition unit 23, tracking target processing unit 24, image presentation unit 25, feature refiner 26, thumbnail generator 27, image player 28, and screen generator 29.

The in-camera tracking information generated by in-camera tracking processing device 4 is accumulated in tracking information accumulation unit 21. The intercamera tracking information generated by inter-camera tracking processing unit 22 is accumulated in tracking information accumulation unit 21. Here, the inter-camera tracking information is information indicating a tracking result when confirmation images (period images) in which persons to be tracked are captured by cameras having a cooperation relationship are chronologically arranged. The inter-camera tracking information is reflected when a timeline screen (tracking target confirmation screen) is generated by the confirmation image presenter 39 to be described later. Although inter-camera tracking information is accumulated in tracking information accumulation unit 21 such that the monitoring person can confirm the past tracking result (tracking history), it may be temporarily stored.

Input information acquisition unit 23 performs a process of acquiring input information based on an input operation, in response to the input operation by a monitoring person using input device 6 such as a mouse.

Tracking target processing unit 24 includes search condition setting unit 31, tracking target setter 32, and additional tracking target setter 33.

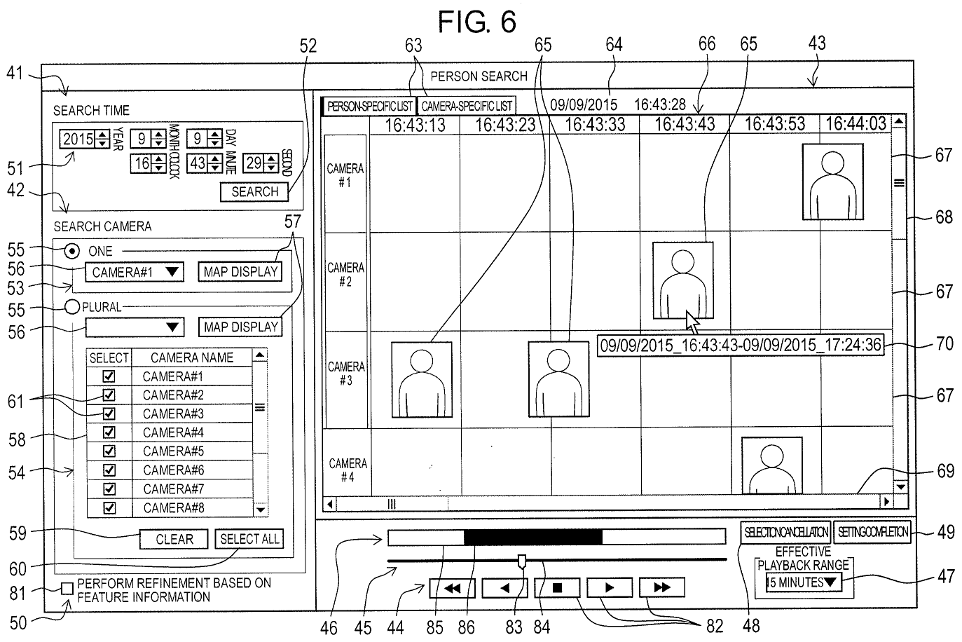

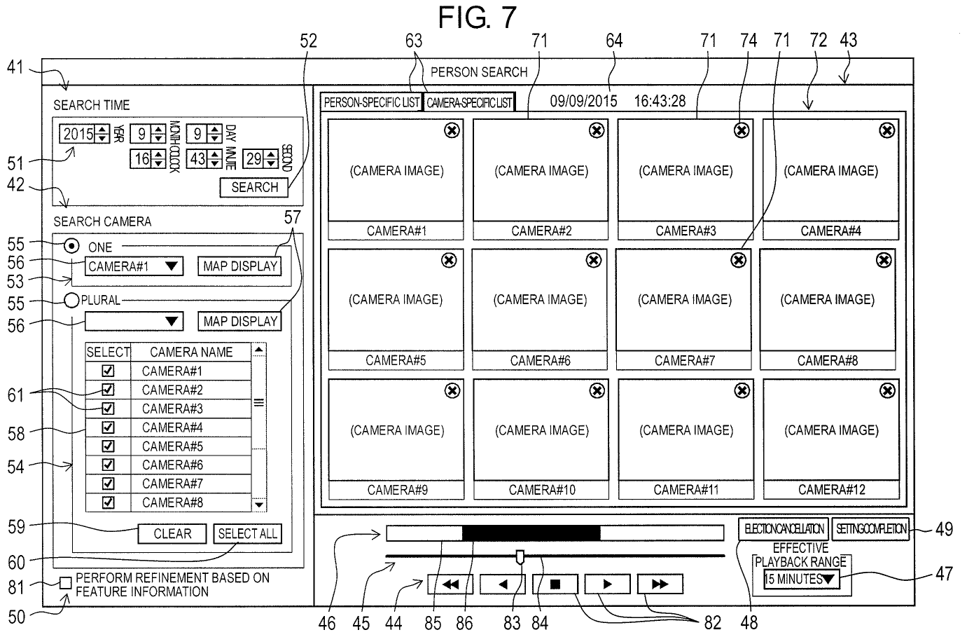

Search condition setter 31 performs a process of setting a search condition for finding out an image in which a person who is a tracking target is captured, in response to an input operation of a monitoring person. In the present exemplary embodiment, the person search screen (tracking target search screen, see FIGS. 6 and 7) is displayed on monitor 7, and the person search screen allows the monitoring person to input the photographing date and time and information on camera 1 as the search condition, on the person search screen.

Tracking target setter 32 performs a process of displaying on the person search screen, the date and time and the image of camera 1, conforming to the search condition, from among images accumulated in recorder 2, based on the search condition set by search condition setter 31 and the in-camera tracking information accumulated in tracking information accumulation unit 21, allowing the monitoring person to select an image on the person search screen to designate a person who is a tracking target, and setting the designated person as the tracking target.

Inter-camera tracking processing unit 22 includes link score calculator 35 (evaluation value calculator), initial tracking information generator 36, candidate selector 37, and tracking information corrector 38.

Link score calculator 35 acquires the in-camera tracking information on each camera-1 from tracking information accumulation unit 21, and calculates a link score (evaluation value) representing a degree of possibility that the persons who are detected and tracked in the in-camera tracking process of each camera 1 are the same person. In this process, the link score is calculated based on the tracking information such as the detection time of the person (the imaging time of the frame), the detection position of the person, the movement speed of the person, and the color information of the person image. In a case where there is a plurality of persons who may be the same person, in the same camera, it is also possible to calculate a plurality of link scores. The link scores of the respective cameras 1 may be either accumulated in tracking information accumulation unit 21 or the like, or temporarily accumulated.

Initial tracking information generator 36 performs a process of sequentially selecting for each camera 1, a person having the highest link score, that is, having a highest possibility of being the same person, with the person set as the tracking target by tracking target setter 32 as a starting point, from among the persons tracked by the in-camera tracking of camera 1 which is in the cooperation relationship, and generating initial tracking information (inter-camera tracking information) in which those persons are associated as the same person.

Specifically, first, a person having the highest link score is selected from among the persons who are tracked by in-camera tracking of camera 1 which is in cooperative with camera 1 that captures an image (tracking target designating image) when the person is designated as the tracking target on the person search screen, and next, a person having the highest link score is selected from among the persons who are tracked by in-camera tracking of camera 1 which is in cooperative with camera 1 that captures the selected person. Such a person selection process is repeated for each camera 1 which is in a cooperation relationship. Such a person selection process is performed both before and after the tracking target designating image temporally, and when the highest link score becomes equal to or less than a predetermined threshold, it is determined that there is no person set as the tracking target in the monitoring area, and the selection of a person is ended.

Image presentation unit 25 includes confirmation image presenter 39, and candidate image presenter 40.

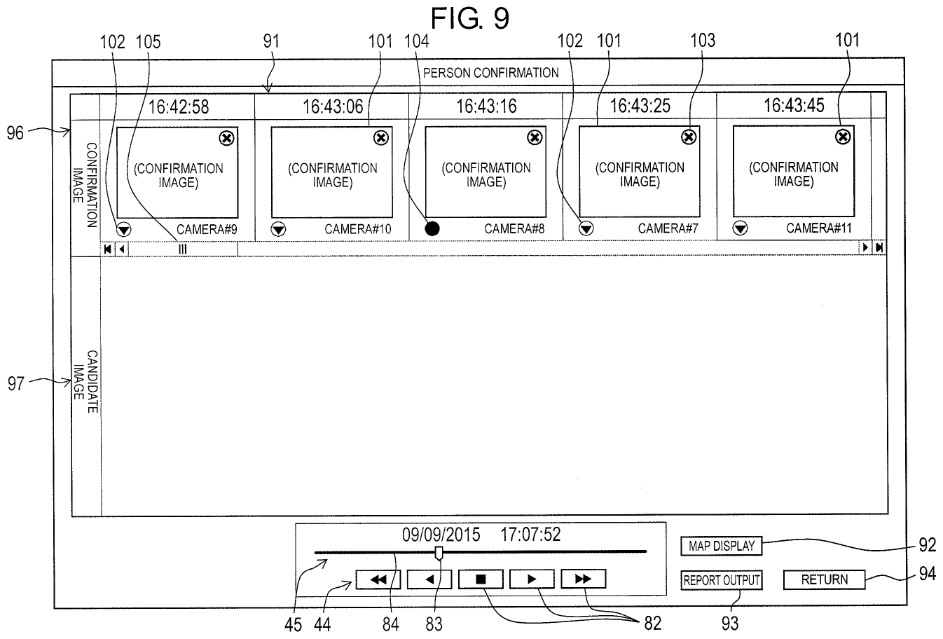

Confirmation image presenter 39 performs a process of extracting an image of the person having the highest link score, that is, an image with the highest possibility of capturing the person to be tracked, for each camera 1, as a confirmation image, based on the initial tracking information generated by initial tracking information generator 36, and presenting the confirmation image, specifically, displaying a timeline screen in a confirmation state (a tracking target confirmation screen, see FIG. 9) in which confirmation images are arranged and displayed in order of imaging time, on monitor 7.

In a case where there is an error in the confirmation image presented by confirmation image presenter 39, that is, there is an error in the initial tracking information generated by initial tracking information generator 36, candidate selector 37 of inter-camera tracking processing unit 22 performs a process of selecting, as a candidate person, a person who is possibly a person set as the tracking target, from among the people who are tracked by in-camera tracking during a period corresponding to the confirmation image with an error or missing.

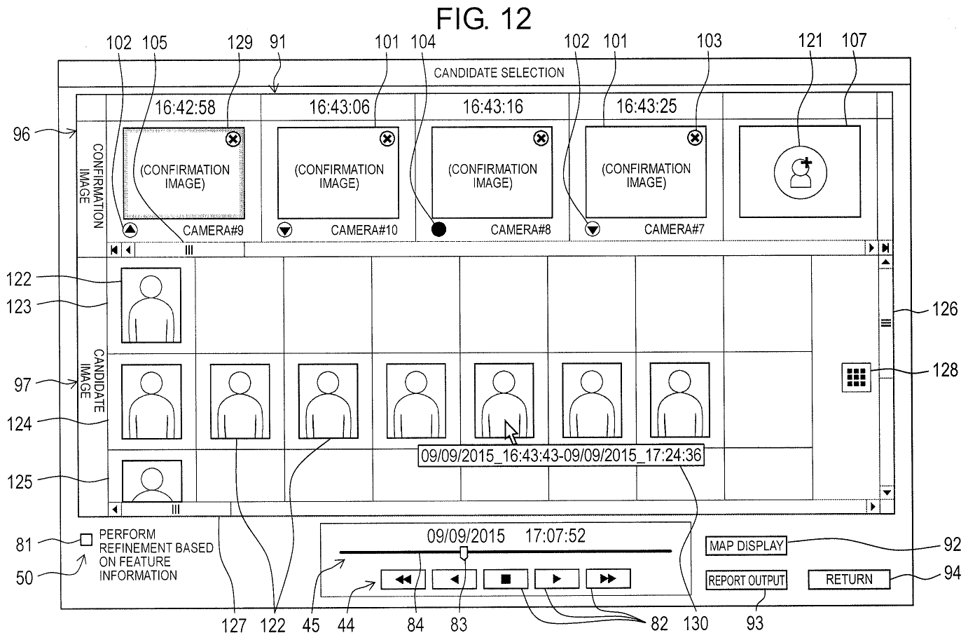

In a case where there is an error or missing in the confirmation image presented by confirmation image presenter 39, candidate image presenter 40 extracts an image related to the candidate person selected by candidate selector 37, that is, an image with a possibility of capturing the person set as the tracking target, as the candidate image, and presents the candidate image. Specifically, a process of displaying the timeline screen in the candidate display state (the candidate selection screen, see FIG. 12) in which a predetermined number of candidate images are displayed on monitor 7, and allowing the monitoring person to select a candidate image capturing the person set as the tracking target on the screen is performed.

In a case where there is an appropriate candidate image among the candidate images presented by candidate image presenter 40, tracking information corrector 38 performs a process of correcting the tracking information on the person set as the tracking target such that the person corresponding to the candidate image is associated with the person set as the tracking target and generating corrected tracking information.

At this time, similarly to the process of generating the initial tracking information, tracking information corrector 38 sequentially selects for each camera 1, a person having the highest link score, that is, having a highest possibility of being the same person, starting from the person corresponding to the candidate image, from among the persons tracked by the in-camera tracking of camera 1 which is in the cooperation relationship, and generates corrected tracking information in which those persons are associated as the same person. In the tracking information correction process, the person set by tracking target setter 32, the person corresponding to the confirmation image for which a confirmation operation is performed by the monitoring person, and the person corresponding to the candidate image replaced with the confirmation image already having an error are excluded from the correction target.

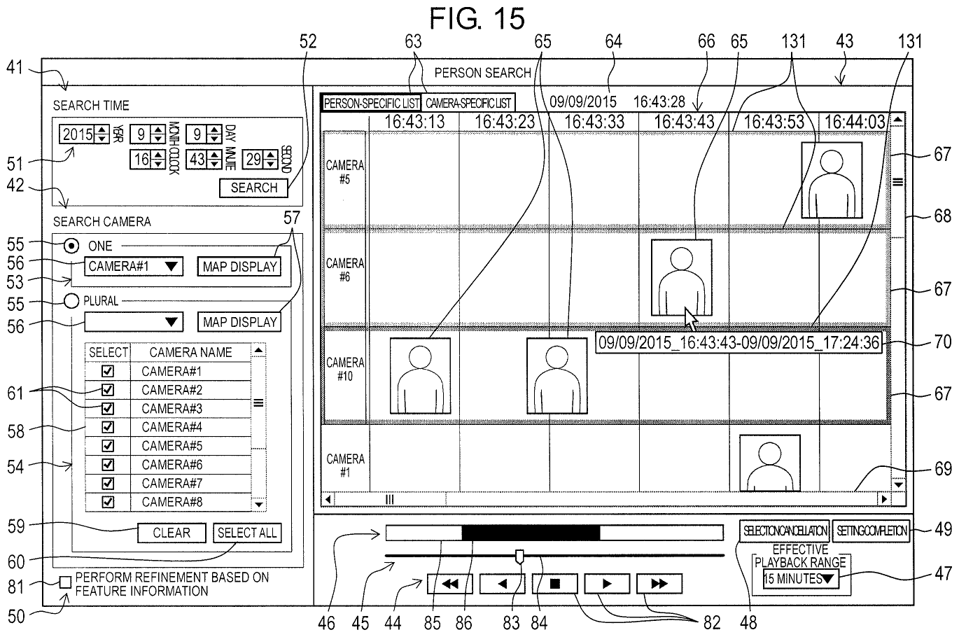

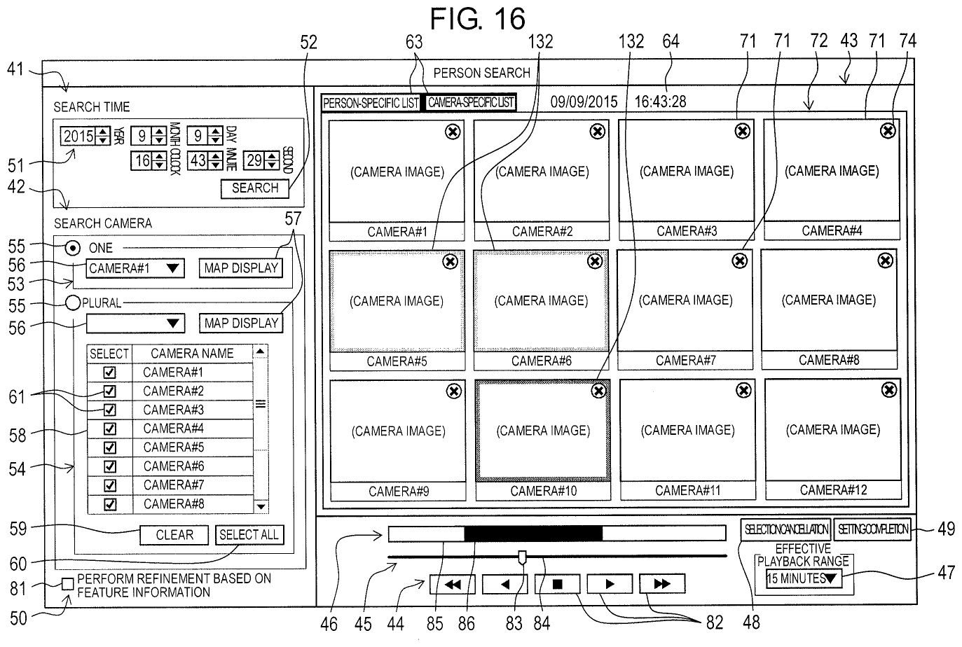

In a case where there is no appropriate candidate image among candidate images presented by candidate image presenter 40, additional tracking target setter 33 of tracking target processing unit 24 performs a process of displaying on monitor 7, a person search screen (a tracking target search screen, see FIGS. 15 and 16) in which images accumulated in recorder 2 are displayed, allowing the monitoring person to designate a person set as a tracking target, from among the images during a period corresponding to the confirmation image with an error or a missing confirmation image, on the person search screen, and additionally setting the designated person as a tracking target.

Tracking information corrector 38 of inter-camera tracking processing unit 22 performs a process of associating the person set as the tracking target by additional tracking target setter 33 with the person set as the tracking target by tracking target setter 32, correcting tracking information on a person set as the tracking target, and generating corrected tracking information.

Feature refiner 26 performs a process of refining a person to be searched, that is, the person of the thumbnail image (tracking target image) to be displayed on the person search screen (see FIG. 6), based on the feature information of the person designated as the tracking target. Feature refiner 26 performs a process of refining a person to be a candidate, that is, a person of the thumbnail image (candidate image) to be displayed on the timeline screen in the candidate display state (see FIG. 12), based on the feature information of the person designated as the tracking target. This process can also be applied to the case of setting an additional person as a tracking target.

Here, the feature information is, for example, information on sex, age, height, the color of hair, the color of clothes, hats and accessories being worn, the color of goods such as bags being carried, or the like. In a case of refining persons to be searched, feature information of the person to be tracked may be set by inputting an image capturing the person is the tracking target, or inputting feature information from the operation input by the user. In a case of refining persons to be candidates, feature information acquired from the image of the person designated as the tracking target may be used.

Thumbnail generator 27 cuts out a person area from the camera image and generates a thumbnail image. In the present exemplary embodiment, during in-camera tracking performed by in-camera tracking processing device 4, a person frame surrounding a person area (for example, an upper body region of a person) is set on the camera image, and the region of the person frame is cut out from the camera image to generate a thumbnail image.

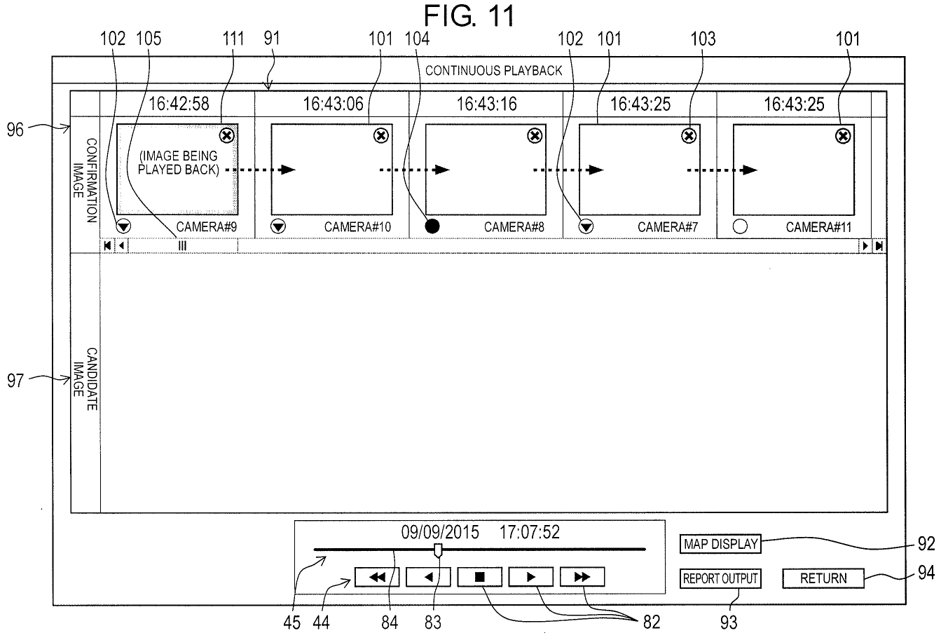

Image player 28 performs a process of displaying the captured images from camera 1 as a moving image on the screen displayed on monitor 7. In the present exemplary embodiment, a process of displaying the timeline screen in a continuous playback state (the continuous playback screen, see FIG. 11) on monitor 7 is performed, and on the timeline screen, continuous playback of sequentially displaying the captured images from each camera 1 in which the person to be tracked is captured, as a moving image, with the lapse of time is performed.

Image player 28 performs a process of thinning out and playing back thumbnail images to be displayed on the screen of monitor 7. In the thinning playing back, the thumbnail image is played back in a state where the frame rate is lowered from the original frame rate, that is, the frame rate of the captured image output from camera 1, by a process of thinning out the frames. Specifically, thumbnail images are sequentially generated at a predetermined interval corresponding to a frame rate at the time of thinning playing back, from the captured image in the in-camera tracking period (period during which in-camera tracking is performed), and thumbnail images which are arranged in time series are played back and displayed. In addition, the thumbnail image can be played back and displayed at the original frame rate by initial setting or the like.

Screen generator 29 generates a screen to be displayed on the monitor 7, specifically, generates a person search screen (a tracking target search screen, see FIG. 6, FIG. 7, FIG. 15, and FIG. 16) in response to an instruction from tracking target setter 32 and additional tracking target setter 33, generates a timeline screen in a confirmation state (a tracking target confirmation screen, see FIG. 9) in response to an instruction from confirmation image presenter 39, generates a timeline screen in a candidate display state (a candidate selection screen, see FIG. 12) in response to an instruction from candidate image presenter 40, and generates a timeline screen in a continuous playback state (a continuous playback screen, see FIG. 11) in response to an instruction from image player 28.

In addition, each unit of PC 3 shown in FIG. 3 is realized by causing a processor (Central Processing Unit (CPU)) of PC 3 to execute a tracking assistance program (instruction) stored in a memory such as a Hard Disk Drive (HDD). These programs may be installed in PC 3 which is an information processing apparatus in advance and configured as a dedicated device, or may be provided to the user by being recorded in an appropriate program recording medium or through a network, as an application program operating on a predetermined Operating System (OS).

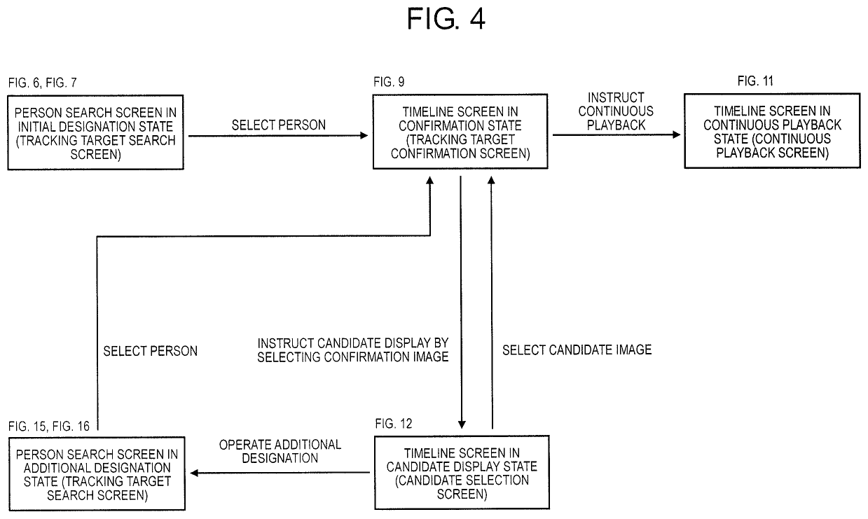

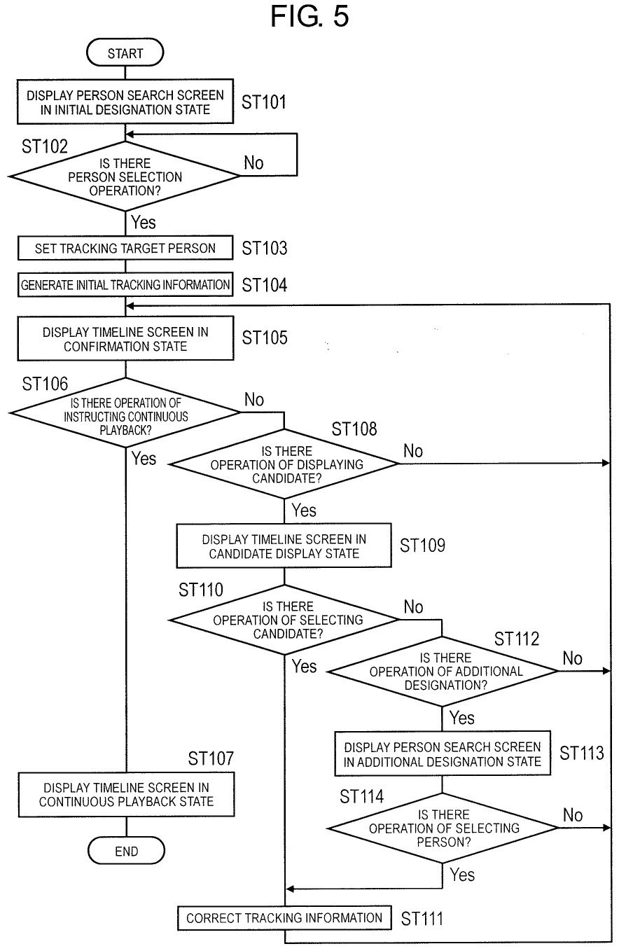

Next, each screen displayed on monitor 7 and processes performed in each unit of PC 3 in response to the operation of the monitoring person performed on each screen will be described. FIG. 4 is an explanatory diagram illustrating a transition situation of a screen displayed on monitor 7. FIG. 5 is a flowchart showing a procedure of a process performed in each unit of PC 3 in response to the operation of the monitoring person performed on each screen.

First, when the operation to start the tracking assistance process is performed in PC 3, a person search screen (tracking target search screen, see FIGS. 6 and 7) in the initial designating state is displayed on monitor 7 (ST101). At this time, the person-specific list mode is set to a display mode in the initial state, first, a person search screen (see FIG. 6) in a person-specific list mode is displayed and can be switched to the person search screen (see FIG. 7) in the camera-specific list mode by the operation of the monitoring person. The user may change the display mode in the initial state.

The person search screen is used to designate the date and time when the person to be tracked performs a problematic action such as shoplifting, designate a place where the person desired to be tracked performs the problematic action, and camera 1 that captures an area through which the person is assumed to pass, find out the thumbnail image in which the person to be tracked is captured, and designate the person to be tracked. If the person to be tracked is captured in the image displayed by designating the date and time and camera 1, the monitoring person performs an operation of designating the person as the tracking target by selecting the image (Yes in ST102).

On the person search screen, when the monitoring person designates a person to be tracked, tracking target setter 32 performs a process of setting the person designated by the monitoring person to a tracking target (ST103). Next, initial tracking information generator 36 performs a process of sequentially selecting a person with the highest link score from the persons detected and tracked by the in-camera tracking process for each camera 1 for each camera and generating initial tracking information (ST104). Then, confirmation image presenter 39 performs a process of extracting the image having the highest possibility of capturing the person set as the tracking target as a confirmation image for each camera 1, based on the initial tracking information, and displaying a timeline screen (a tracking target confirmation screen, see FIG. 9) in the confirmation state in which the confirmation image is displayed, on monitor 7 (ST105).

The timeline screen in the confirmation state is used to allow the monitoring person to check whether there is an error in the inter-camera tracking information (initial tracking information) by the confirmation image. In a case where there is no error in all the confirmation images displayed on the timeline screen in the confirmation state, that is, all the confirmation images are related to a person set as the tracking target, the operation of instructing the continuous playback is performed by the monitoring person (Yes in ST106), and a transition is made to the timeline screen in a continuous playback state (continuous playback screen, see FIG. 11) (ST107).

Continuous playback is performed in which the image from each camera 1 in which the tracking target is captured is sequentially displayed with the lapse of time, on the timeline screen in the continuous playback state.

On the other hand, in a case where a confirmation image with an error is found among the plurality of confirmation images displayed on the timeline screen in the confirmation state, that is, in a case where any confirmation image is not related to the person set as the tracking target or in a case where the confirmation image of the time when the person set as the tracking target is to be captured by any camera 1 is missing, the monitoring person performs an operation of selecting the confirmation image and instructing the display of the candidate image (Yes in ST108).

Then, candidate selector 37 performs a process of selecting a person who is possibly a person set as the tracking target is selected from among the persons tracked by the in-camera tracking in the period corresponding to the confirmation image having an error or the missing confirmation image, and candidate image presenter 40 performs a process of extracting the image of a person selected as a candidate image by candidate selector 37 and displaying a timeline screen (a candidate selection screen, see FIG. 12) in a candidate image display state in which the candidate images are arranged and displayed, on monitor 7 (ST109).

On the timeline screen in the candidate display state, an image with a possibility of capturing the person set as the tracking target is displayed as a candidate image.

In a case where there is an appropriate candidate image, among candidate images displayed on the timeline screen in the candidate display state, that is, a candidate image relating to the person set as the tracking target is found, an operation of selecting the candidate image is performed by the monitoring person (Yes in ST110).

Then, a process of correcting the tracking information such that the person corresponding to the candidate image selected on the timeline screen in the candidate display state is associated with the person who is first designated as the tracking target is performed on tracking information corrector 38 of inter-camera tracking processing unit 22 (ST111). Then, the screen returns to the timeline screen in the confirmation state (ST105), and on the timeline screen, an image in which the result from correcting the tracking information is reflected, that is, the confirmation image of the timed screen is replaced with the camera image in which the person corresponding to the selected candidate image is captured and displayed.

On the other hand, in a case where there is no appropriate candidate image, among candidate images displayed on the timeline screen in the candidate image display state, that is, a candidate image about the person set as the tracking target is not found, the monitoring person performs an operation of selecting additional designation (Yes in ST112), and a transition is made to a person search screen in an additional designation state (a tracking target search screen, see FIGS. 15 and 16) (ST113).

The monitoring person performs a work of searching for an image in which the person set as the tracking target is captured, on the person search screen in the additional designation state. In a case where the image in which the person set as the tracking target is captured is found on the person search screen in the additional designation state, the monitoring person performs an operation of selecting a person of the image as a tracking target by selecting the image (Yes in ST114).

Then, tracking information corrector 38 of inter-camera tracking processing unit 22 performs a process of correcting the tracking information such that the person selected on the person search screen is associated with the person who is first designated as the tracking target (ST111). Then, the screen returns to the timeline screen in the confirmation state (ST105), and the result from correcting the tracking information is reflected, that is, the confirmation image of the timed screen is replaced with the image of the person designated on the person search screen, and the replaced image is displayed on the timeline screen.

As described above, in a case where there is an error in the confirmation image displayed on the timeline screen in the confirmation state, or in a case where the confirmation image is missed, the monitoring person performs an operation of selecting a candidate image, or an operation of searching for and designating a person set as the tracking target, and these operations are repeated until there is no confirmation image with an error, or confirmation image that is missing. When it is checked that there is no error and missing in all the confirmation images, the monitoring person performs an operation of instructing continuous playback (Yes in ST106), and a timeline screen in a continuous playback state (see FIG. 11) is displayed on monitor 7 (ST107).

Hereinafter, each screen shown in FIG. 4 will be described in detail.

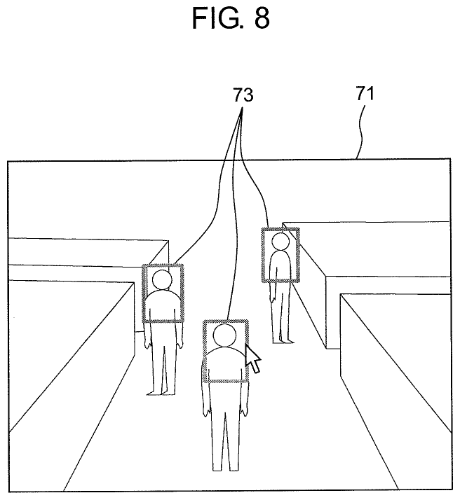

First, a person search screen in the initial designation state (tracking target search screen) illustrated in FIG. 4 will be described. FIG. 6 is an explanatory diagram showing a person search screen in an initial designation state in a person-specific list mode. FIG. 7 is an explanatory diagram showing a person search screen in the initial designation state in a camera-specific list mode. FIG. 8 is an explanatory diagram showing a main part of the person search screen in the camera-specific list mode.

The person search screen in the initial designation state (tracking target search screen) is used to designate the date and time when the person desired to be tracked performs a problematic action such as shoplifting, search for the image in which the person to be tracked is captured, and designate the person to be tracked on the image.

The person search screen is provided with search date and time designation portion 41, search camera designation portion 42, image display portion 43, playback operation portion 44, display time adjustment portion 45, display period designation portion 46, adjustment range designation portion 47, selection cancellation button 48, setting completion button 49, and feature refining designation portion 50.

Search date and time designation portion 41 is provided with date and time input portion 51 and search button 52. In date and time input portion 51, the monitoring person inputs the date and time that is the center of the period during which the person to be tracked is assumed to be captured. When the date and time is input in date and time input portion 51 and search button 52 is operated, the captured image of the inputted date and time is displayed in image display portion 43.

Search camera designation portion 42 is provided with single-camera selecting portion 53 and plural-cameras selecting portion 54. Single-camera selecting portion 53 and plural-cameras selecting portion 54 are provided with radio button 55, menu selecting portion 56, and map display button 57, respectively.

Two radio buttons 55 are used to select one search mode of the single camera mode and the plural camera mode. In the single camera mode, single camera 1 is designated, and an image in which the person to be tracked target is captured is found out from among the images from single camera 1. In the plural camera mode, plural cameras 1 are designated, and an image in which the person to be tracked is captured is found out from among images from plural cameras 1.

In menu selecting portion 56, camera 1 can be selected by using a pull-down menu. When map display button 57 is operated, a map display screen (not shown) is displayed. On the map display screen, a camera icon indicating the position of camera 1 is superimposed on the map image showing the layout in the store, and camera 1 can be selected on the map display screen.

Plural-cameras selecting portion 54 is provided with check box list 58, clear button 59, and select all button 60. In check box list 58, the required number of cameras 1 can be selected by check box 61. When clear button 59 is operated, the selected states of all cameras 1 are canceled. When all select buttons 60 are operated, all cameras 1 can be set to the selected state.

Information on the selection state of the search mode (the single camera mode and the plural camera mode) and information on the selected state of camera 1 are retained in an information storage unit, not shown, and at the next start-up, a person search screen is displayed with the search mode and camera 1 being selected at the time of last termination as it is.

In image display portion 43, tab 63 and date and time display portion 64 are provided. Tab 63 is used for switching between the display modes of the person-specific list mode and the camera-specific list mode. When tab 63 of the person-specific list is selected, a person search screen in the person-specific list mode shown in FIG. 6 is displayed. When tab 63 of the camera-specific list is selected, a person search screen in the camera-specific list mode shown in FIG. 7 Is displayed.

On the person search screen in the person-specific list mode shown in FIG. 6, person-specific image list 66 in which thumbnail images 65 of respective persons to be searched is displayed as a list is displayed in image display portion 43.

In person-specific image list 66, camera-specific display fields 67 for cameras 1 are arranged in a vertical direction. In camera-specific display field 67, thumbnail image 65 is displayed separately for each camera 1 that has captured thumbnail image 65. In person-specific image list 66, thumbnail images 65 are arranged side by side in time series, and in camera-specific display field 67, thumbnail image 65 of the person tracked in the in-camera tracking by corresponding camera 1 is displayed in the order in which the tracking is started. Thumbnail image 65 is displayed at the position of the tracking start time. On the person search screen of the initial designation state shown in FIG. 6, camera-specific display fields 67 are arranged in order of the camera number from the top.

In person-specific image list 66, by performing an operation (clicking) of selecting thumbnail image 65 and designating a person of thumbnail image 65 as tracking target, that person is set as a tracking target. At this time, since the person who is small in the captured image is enlarged and displayed in thumbnail image 65, identification of a person becomes easier, as compared with the case where the captured image is displayed as it is, so the problem of missing the person to be tracked is eliminated and it is possible to efficiently find the person to be tracked.

Further, image display portion 43 is provided with vertical scroll bar 68 and horizontal scroll bar 69. By operating vertical scroll bar 68, person-specific image list 66 can be slid in the vertical direction and displayed, and by operating horizontal scroll bar 69, person-specific image list 66 can be slid in the horizontal direction and displayed. This makes it possible to efficiently find thumbnail image 65 of the person to be tracked, even in a case where camera 1 imaging the person to be tracked and the imaging time are uncertain.

Further, when a mouse over operation of overlaying the cursor on thumbnail image 65 displayed in person-specific image list 66 is performed, thumbnail image 65 is thinned out and played back. According to this, it is possible to confirm thumbnail image 65 over the entire in-camera tracking period regarding the person of thumbnail image 65 in a short time. In the initial state (stopped state) of thumbnail image 65, thumbnail image 65 extracted from the image captured at the center time of the tracking period in the in-camera tracking is displayed.

When a mouse over operation is performed on thumbnail image 65, tool tip 70 (display frame) for displaying time information on thumbnail image 65 appears. In tool tip 70, an in-camera tracking period (tracking start time and tracking end time) related to a person appearing in thumbnail image 65 is displayed. Thus, the user can recognize the accurate time when the person set as the tracking target appears.

On the other hand, on the person search screen in the camera-specific image list mode shown in FIG. 7, camera-specific image list 72 in which camera images 71 as the whole captured images by cameras 1 are displayed as a list is displayed in image display portion 43. In camera-specific image list 72, camera images 71 are displayed side by side from the top in order of the camera number.

As shown in FIG. 8, person frame 73 (tracking mark) is displayed in the image area of the person detected from camera image 71, that is, the person to be subjected to the in-camera tracking is displayed in camera image 71, and an operation (clicking) of selecting person frame 73 is performed, such that the person is set as the tracking target.

In image display portion 43, delete button 74 is provided for each camera image 71. By operating delete button 74, camera image 71 can be deleted. Thus, by deleting camera image 71 determined to be unnecessary while sequentially viewing camera image 71, the number of camera images 71 displayed as a list in image display portion 43 is reduced, so it becomes easy to find a person set as the tracking target. When the number of camera images 71 displayed as a list changes, the size of each camera image 71 changes accordingly, and when the number of camera images 71 displayed as a list is reduced, each camera image 71 is displayed large.

Feature refining designation portion 50 is used to select whether to perform refinement based on feature information or not, the refinement based on the feature information is performed by checking check box 81, and thumbnail images 65 of only the persons whose appearance features are similar to the person to be tracked whose feature information is previously input is displayed in person-specific image list 66.

Playback operation portion 44 is used to perform operations related to playback of image displayed in image display portion 43. Various buttons 82 such as playback, reverse playback, stop, fast forward, and rewind are provided in playback operation portion 44, and it is possible to efficiently view images and to efficiently find an image capturing the person to be tracked, by operating buttons 82.

Display time adjustment portion 45 is used to adjust the display time of the image displayed in image display portion 43. Display time adjustment portion 45 is a so-called seek bar, and slider 83 is provided movably along bar 84. When an operation of shifting (dragging) slider 83 is performed using input device 6 such as a mouse, the image at the time indicated by slider 83 is displayed on image display portion 43. Bar 84 defines an adjustment range of the display time centered on the time designated in search date and time designation portion 41.

Display period designation portion 46 is used for the monitoring person to input a period during which the person who is the tracking target is captured as a display period. Display period designation portion 46 is a so-called duration bar, and a bar 86 representing a display period is displayed in frame 85. In a case where an image in which a person to be tracked is displayed in image display portion 43 and person frame 73 is not displayed on the person, display period designation portion 46 is used for the monitoring person to designate a period during which the person to be tracked is captured in the image, instead of selecting person frame 73.

Adjustment range designation portion 47 is used to designate the adjustment range (effective playback range) of the display time of image displayed in image display portion 43, that is, the movement range of slider 83 defined by bar 84 of display time adjustment portion 45. In adjustment range designation portion 47, the adjustment range of the display time can be selected from predetermined times (for example, 5 minutes, 15 minutes, or the like) by a pull-down menu.

When selection cancellation button 48 is operated, the contents designated in display period designation portion 46 are discarded, and the designation of the display period (the start time and the end time) can be redone. When setting completion button 49 is operated, transition is made to the timeline screen (see FIG. 9) in the confirmation state.

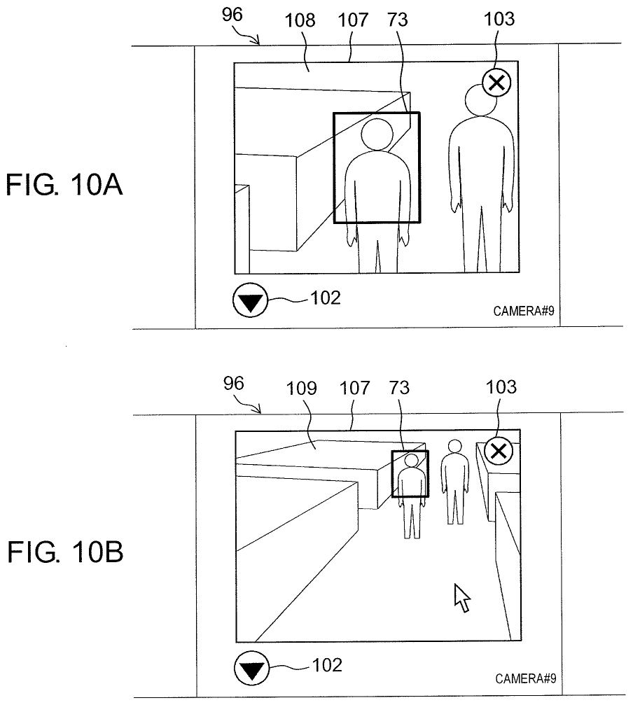

Next, the timeline screen in a confirmation state (tracking target confirmation screen) shown in FIG. 4 will be described. FIG. 9 is an explanatory diagram illustrating a timeline screen in a confirmation state. FIGS. 10A and B are explanatory diagrams illustrating a main part of the timeline screen in the confirmation state.

On the person search screen shown in FIGS. 6 and 7, when the monitoring person operates setting completion button 49 after designating a person to be tracked, transition is made to the timeline screen in the confirmation state shown in FIG. 9.

On the timeline screen in the confirmation state, the captured image from each camera 1 having the highest possibility of capturing the person set as the tracking target on the person search screen is displayed as confirmation image 101 to allow the monitoring person to check whether there is an error in the inter-camera tracking information (initial tracking information) by using confirmation image 101.

On the timeline screen, image display portion 91, playback operation portion 44, display time adjustment portion 45, map display button 92, report output button 93, and return button 94 are provided.

In the image display portion 91, a confirmation image display portion 96 and a candidate image display portion 97 are provided. The candidate image display portion 97 is used for displaying images on the timeline screen in the candidate display state (see FIG. 12), which will be described in detail later.

In confirmation image display portion 96, images obtained by sequentially capturing a person who is a tracking target by respective cameras 1 in a period from when the person who is the tracking target enters the monitoring area (in the store) to start tracking and exits the monitoring area are displayed side by side as confirmation images 101 for respective cameras 1 in order of imaging time, that is, from the left end in order of imaging time from the earliest imaging time. Further, for each confirmation image 101, the imaging time and the name of camera 1 are displayed.

In the initial state when the timeline screen is opened, confirmation image 101 at the tracking start time when in-camera tracking is started by camera 1 is displayed as a still image. When there is no error in confirmation image 101, a transition can be made to the continuous playback in response to the operation of playback operation portion 44. In confirmation image 101, person frame 73 is displayed on the person detected and tracked from confirmation image 101, similar to the person search screen (see FIG. 8).

In confirmation image display portion 96, candidate display button 102, and delete button 103 are provided for each confirmation image 101. When candidate image display button 102 is operated, the transition is made to the timeline screen (see FIG. 12) in the candidate display state. By operating delete button 103, the confirmation image 101 can be deleted.

In confirmation image display portion 96, a tracking target designation image, that is, an image designating a person as a tracking target on the person search screen (see FIGS. 6 and 7) is also displayed as confirmation image 101, and mark 104 for identifying the tracking target designation image is displayed in confirmation image 101, instead of candidate display button 102. Instead of mark 104, a frame image representing the tracking target designation image may be displayed. A frame image representing the confirmed state may be displayed in confirmed confirmation image 101.

Further, confirmation image display portion 96 is provided with horizontal scroll bar 105. By operating horizontal scroll bar 105, confirmation image 101 can be slid and displayed in the arrangement direction of confirmation image 101, that is, in the horizontal direction.

Since it is determined whether or not confirmation image 101 displayed in confirmation image display portion 96 belongs to the person designated as the tracking target, on the timeline screen configured in this way, the monitoring person can check whether or not there is an error in the inter-camera tracking information (initial tracking information) regarding the person designated as the tracking target. In a case where there is an error in the inter-camera tracking information, the person who is the tracking target is not captured in confirmation image 101, or the person who is the tracking target is captured but the person frame is displayed on a person different from the person set as the tracking target, and the monitoring person can check whether or not there is an error in the inter-camera tracking information by viewing confirmation image 101.

Here, in a case where there is no error in all confirmation images 101 displayed in confirmation image display portion 96, that is, the person who is the tracking target is captured in all confirmation images 101, and the person frame is displayed on the person, the operation of instructing continuous playback, that is, playback button 82 in playback operation portion 44 is operated. A transition is made to the timeline screen in a continuous playback state shown in FIG. 11.

Here, as shown in FIG. 10A, in image display frame 107 of confirmation image display portion 96, in the initial state, enlarged image 108 including a person area (area of person frame 73) is displayed as confirmation image 101. On enlarged image 108, person frame 73 is displayed on a person corresponding to confirmation image 101. Enlarged image 108 is obtained by calculating the enlargement ratio such that an enlarged image falls within the size of the display frame of confirmation image 101, in a state where a predetermined margin is secured around the person area and the aspect ratio of the image is held, and extracting an area centered on the center point of person frame 73 from the captured image, based on the enlargement ratio. In enlarged image 108, since the person is enlarged and displayed from the original captured image, it is easy to identify the person.

When the mouseover operation is performed on enlarged image 108, as shown in FIG. 10B, confirmation image 101 displayed in image display frame 107 is switched from enlarged image 108 to camera image 109. The entire imaging area of camera 1 appears in camera image 109, and compared with enlarged image 108, it becomes easier to recognize the situation around the person.

When an operation (click) of selecting confirmation image 101 (camera image 109) is performed, an enlarged display screen (not shown) for enlarging and displaying confirmation image 101 is popped up in another window, and confirmation image 101 can be observed in detail on this screen.

Playback operation portion 44 and display time adjustment portion 45 are used to display confirmation image 101 as a moving image on the timeline screen (see FIG. 11) in a continuous playback state, which is similar to the person search screen (see FIGS. 6 and 7), and will be described in detail later.

When map display button 92 is operated, a map display screen (not shown) is displayed. It is possible to check the position of camera 1 from the map display screen. The map display screen is obtained by superimposing camera icons indicating the positions of camera 1 on the map image showing the layout in the store, and it is possible to check the position of camera 1 that has captured confirmation image 101.

Report output button 93 is operated to output a report on confirmation image 101 for each camera 1 arranged in time series. Return button 94 is operated to return to the timeline screen at the confirmation state from the timeline screen in the candidate display state (FIG. 12).

Next, the timeline screen (continuous playback screen) in a continuous playback state shown in FIG. 4 will be described. FIG. 11 is an explanatory diagram illustrating a timeline screen in a continuous playback state.

Although the timeline screen in the continuous playback state has substantially the same configuration as the timeline screen in the confirmation state (see FIG. 9), continuous playback is performed in which confirmation images 101 displayed in confirmation image display portion 96 are sequentially displayed as a moving image with the lapse of time, on the timeline screen in the continuous playback state. Frame image 111 indicating that playback is in progress is displayed on confirmation image 101 being played back.

In playback operation portion 44, the start point (left end) of bar 84 that defines the movement range of slider 83 for adjusting the display time of confirmation image 101 displayed in confirmation image display portion 96, that is, the adjustment range of the display time is the start time of confirmation image 101 having the earliest imaging time, and the end point (right end) of bar 84 is the end time of confirmation image 101 having the latest imaging time.

Since confirmation images 101 are displayed side by side sequentially from the left starting from the confirmation image having the earliest imaging time on the timeline screen in the continuous playback state, confirmation image 101 is played back sequentially from the left during continuous playback, but in a case where all confirmation images 101 do not fit in confirmation image display portion 96, a process of automatically sliding confirmation images 101 at an appropriate timing is performed, so the monitoring person can view a situation in which all confirmation images 101 are continuously played back, without performing any special operation.

When an operation (click) of selecting confirmation image 101 is performed, an enlarged display screen (not shown) for enlarging and displaying confirmation image 101 is popped up in a separate window, and confirmation image 101 can be displayed as a moving image in a state enlarged in the enlarged display screen, and confirmation image 101 can be continuously played back on the enlarged display screen.

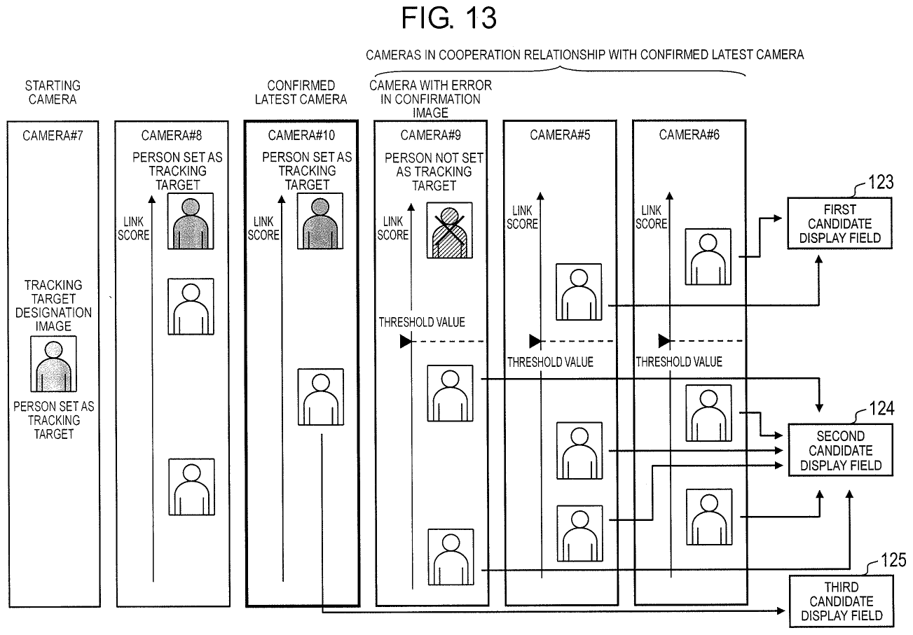

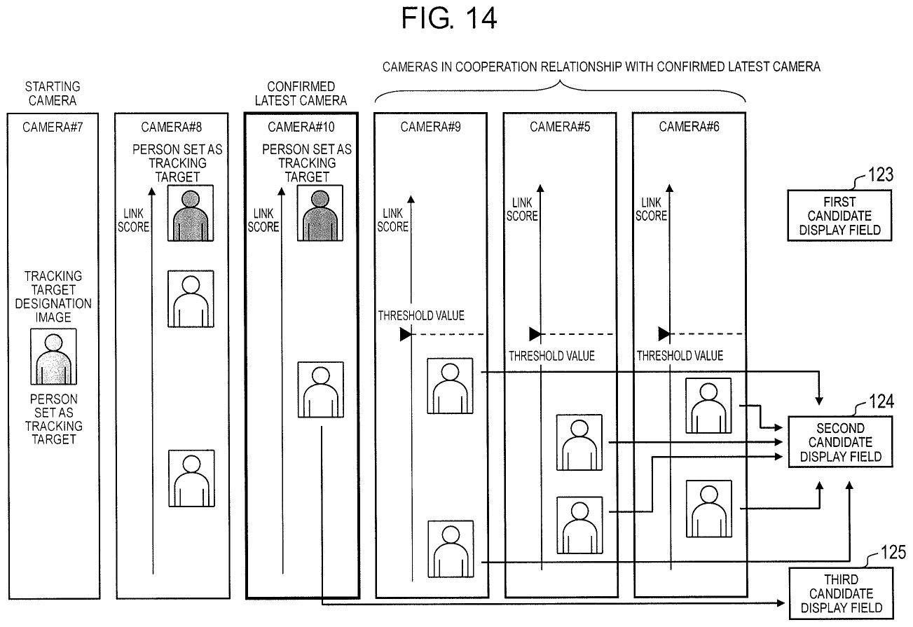

Next, the timeline screen in the candidate display state (candidate selection screen) shown in FIG. 4 will be described. FIG. 12 is an explanatory diagram illustrating the timeline screen in the candidate display state. FIGS. 13 and 14 are explanatory diagrams illustrating a candidate image displayed on the timeline screen in the candidate display state.

In a case where there is an error in confirmation image 101 displayed on the timeline screen (see FIG. 9) in the confirmation state, that is, the person who is the tracking target is not captured in one of confirmation images 101, or the person who is the tracking target is captured but the person frame indicating the tracking target is displayed on a person different from the person set as the tracking target, transition is made to the timeline screen in the candidate display state shown in FIG. 12 by the monitoring person operating candidate display button 102 corresponding to confirmation image 101.

In confirmation image display portion 96, image display frame 107 is in a blank state (state where confirmation image 101 is not displayed) at the time before the person set as the tracking target is started to be tracked or at the time after the tracking is ended, and instead thereof image addition icon 121 is displayed. Here, in a case where image display frame 107 is in the blank state at the time when the person set as the tracking target is to be captured by one of cameras 1, that is, confirmation image 101 is missing, transition is made to the timeline screen in the candidate display state shown in FIG. 12 by operating image addition icon 121 of image display frame 107.

On the timeline screen in the candidate display state (candidate selection screen), in a case where there is an error in confirmation image 101 displayed on the timeline screen in the confirmation state or in a case where confirmation image 101 is missing, an image with a possibility of capturing the person set as the tracking target is displayed as a candidate image in addition to confirmation image 101 to allow the monitoring person to select the image, so it is possible to change confirmation image 101 with an error, and add confirmation image 101 at the time when confirmation image 101 is missing.

When candidate display button 102 or image addition icon 121 is operated again on the timeline screen in the candidate display state, the screen returns to the timeline screen in the confirmation state.

The timeline screen in the candidate display state is substantially the same as the timeline screen in the confirmation state (see FIG. 9), but thumbnail images 122 as the candidate images are displayed and a list in candidate image display portion 97. On the timeline screen in the candidate display state, frame image 129 indicating the selected state is displayed in a predetermined display color (for example, yellow) in image display frame 107 of confirmation image 101 corresponding to the candidate image.

Candidate image display portion 97 is provided with first candidate display field 123 in the upper row, second candidate display field 124 in the middle row, and third candidate display field 125 in the lower row, and thumbnail images 122 are displayed side by side in candidate display fields 123, 124, and 125.

Here, in the present exemplary embodiment, as shown in FIG. 13, starting from camera 1 which has captured the image (tracking target designation image) selected upon designation of a person as a tracking target, camera 1 which has captured the person who is the tracking target is sequentially specified, based on the inter-camera tracking information. At this time, a process for selecting the person with the highest link score, that is, the person with the highest possibility of being the same person, from among the persons tracked by in-camera tracking of camera 1 in the cooperation relationship is sequentially repeated, and confirmation image 101 of the selected person is displayed on the timeline screen.

Here, when there is camera 1 with an error in confirmation image 101 displayed on the timeline screen, with reference to camera 1 (confirmed latest camera) whose confirmation image 101 is confirmed as having no error in confirmation image 101 in the immediate vicinity of camera 1 to be changed, that is, camera 1 that has tracked a person set as the tracking target immediately before or after camera 1 to be changed, thumbnail image 122 (candidate image) of the person tracked by the in-camera tracking of camera 1 in the cooperation relationship with camera 1 is displayed on the timeline screen.

At this time, in first candidate display field 123, among the persons tracked by the in-camera tracking of camera 1 in the cooperation relationship with the confirmed latest camera, thumbnail images 122 of persons whose link score is equal to or larger than a predetermined threshold value in addition to the person in the confirmation image 101 are displayed. Here, in a case where there is a plurality of corresponding persons, thumbnail images 122 are displayed in a row in the horizontal direction from left to right in the descending order of link scores.

In second candidate display field 124, among the persons tracked by the in-camera tracking of camera 1 in the cooperation relationship with the confirmed latest camera, thumbnail images 122 of persons whose link score is less than a predetermined threshold value are displayed. Here, in a case where there is a plurality of corresponding persons, thumbnail images 122 are displayed in a row in the horizontal direction from left to right in the descending order of link scores.

In third candidate display field 125, among the persons tracked by the in-camera tracking of the confirmed latest camera, thumbnail images 122 of persons who are timely close, that is, persons tracked before or after the tracking period of the person who is confirmed as the tracking target are displayed. For example, in-camera tracking is interrupted when a person enters the toilet, and the in-camera tracking is restarted when a person comes out of the toilet, and at this time, by the in-camera tracking, the person who enters the toilet and the person who came out of the toilet may not be associated as the same person but may become different persons in the camera tracking. In this way, in a case where a person who is a tracking target does not leave the imaging area of the confirmed latest camera and is tracked as a different person, there is a person who is a tracking target, among the persons who are tracked by in-camera tracking of the confirmed latest camera, and thumbnail image 122 of such a person is displayed in third candidate display field 125.

As shown in FIG. 14, if confirmation image 101 of the time to be displayed on the timeline screen is missing, with reference to camera (confirmed latest camera) whose confirmation image 101 is confirmed as having no error in confirmation image 101 in the immediate vicinity of time when confirmation image 101 is missing, that is, camera 1 that has tracked a person set as the tracking target immediately before or after camera 1 to be added, thumbnail image 122 (candidate image) of the person tracked by the in-camera tracking of camera 1 in the cooperation relationship with camera 1 is displayed on the timeline screen.

At this time, since there is no person whose link score is equal to or larger than the predetermined threshold value, thumbnail image 122 is not displayed in first candidate display field 123. On the other hand, second candidate display field 124 and third candidate display field 125 are the same as those shown in FIG. 13.

In this way, the thumbnail image of a person having a high possibility of being a person set as the tracking target is displayed in first candidate display field 123, the thumbnail image of a person whose possibility of being a person set as the tracking target is not so high is displayed in second candidate display field 124, and the thumbnail image of a person having a possibility of being a person set as the tracking target exceptionally is displayed in third candidate display field 125. Therefore, by viewing thumbnail images 122 in order from the top in the order of first candidate display field 123 in the upper row, second candidate display field 124 in the middle row, and third candidate display field 125 in the lower row, it is possible to efficiently find thumbnail images 122 of the person set as the tracking target.

As shown in FIG. 12, similarly to the person search screen (see FIG. 6) in the person-specific list mode, thumbnail image 122 is thinned out and played back in candidate image display portion 97, by performing a mouse over operation on thumbnail image 122. By performing a mouse over operation on thumbnail image 122, tool tip 130 of the time information is displayed.

Candidate image display portion 97 is provided with vertical scroll bar 126 and horizontal scroll bar 127. By operating vertical scroll bar 126, candidate display fields 123, 124, and 125 can be slid in the vertical direction and displayed, and by operating horizontal scroll bar 127, candidate display field 123, 124, and 125 can be slid in the horizontal direction and displayed.

On the timeline screen in the candidate display state, feature refining designation portion 50 is provided. Feature refining designation portion 50 is used to select whether to perform refinement based on feature information or not, the refinement based on the feature information is performed by checking check box 81, and thumbnail image 122 of only the person whose appearance features are similar to the person who is the tracking target is displayed in candidate image display portion 97.

In a case where there is an appropriate candidate image, that is, thumbnail image 122 in which the person who is the tracking target is captured is found, among thumbnail image 122 displayed in candidate image display portion 97, on the timeline screen in the candidate display state, the monitoring person performs an operation (click) of selecting thumbnail image 122.

Then, tracking information corrector 38 (see FIG. 3) performs a process of correcting the tracking information such that the person corresponding to thumbnail image 122 (candidate image) selected on the timeline screen in the candidate display state is associated with the person who is designated as the tracking target on the person search screen (see FIGS. 6 and 7). Then, the timeline screen (see FIG. 9) in a confirmation state is displayed on monitor 7, in a state where the result from correcting the tracking information is reflected.

On the timeline screen in the confirmation state, an image in which the result from correcting the tracking information is reflected, that is, an image in which confirmation image 101 selected as having an error on the timeline screen in the confirmation state is replaced with the camera image corresponding to thumbnail image 122 selected on the timeline screen in the candidate display state is displayed. As confirmation image 101 having an error is replaced, preceding and subsequent images 101 of replaced confirmation image 101 may be changed.

That is, in tracking information corrector 38, a process of sequentially selecting a person having the highest link score for each camera 1 is performed, with a person corresponding to thumbnail image 122 (candidate image) as a starting point. In a case where the selected person is different from the person corresponding to confirmation image 101, the replacement of the person occurs and confirmation image 101 is changed accordingly. When tracking information is corrected in tracking information corrector 38, the person set in tracking target setter 32, the person corresponding to confirmation image 101 for which confirmation operation is confirmed by the monitoring person, and the person corresponding to the candidate image 101 replaced with the confirmation image 101 already having an error are excluded from the correction target, so the confirmation image regarding those persons is not changed.

Manual search button 128 is provided in candidate image display portion 97. In a case where there is no appropriate candidate image, that is, thumbnail image 122 of the person set as the tracking target is not found, among candidate images displayed on the timeline screen in the candidate image display state, manual search button 128 is selected, so transition is made to person search screen (see FIG. 1) in the additional designation state shown in FIGS. 15 and 16.

Next, a person search screen in the additional designation state will be described. FIG. 15 is an explanatory diagram showing a person search screen in an additional designation state in a person-specific list mode. FIG. 16 is an explanatory diagram showing a person search screen in an additional designation state in a camera-specific list mode.

The person search screen (tracking target search screen) in the additional designation state is for finding out a person which is a tracking target, by displaying thumbnail image 65 or camera image 71 of the period corresponding to confirmation image 101 with an error, in a case where there is no appropriate image among thumbnail images 122 displayed on the timeline screen in the candidate display state (see FIG. 12). The person search screen in the additional designation state is for finding out a person which is a tracking target, by displaying thumbnail image 65 or camera image 71 of the period corresponding to missing confirmation image 101 on the timeline screen (see FIG. 9) in the confirmation state.

As shown in FIG. 15, the person search screen in the additional designation state in the person-specific list mode is substantially the same as the person search screen (see FIG. 6) in the initial designation state, but the order of camera-specific display field 67 is different from the person search screen in the initial designation state, camera 1 in a cooperation relationship with the confirmed latest camera is displayed at the top, and then the confirmed latest camera is displayed next. Other cameras are displayed in order of camera number. Thus, by preferentially viewing the image of camera 1 in cooperation with the confirmed latest camera, it is possible to efficiently find the image of the person set as the tracking target.

In the person search screen in the additional designation state in the person-specific list mode, frame image 131 is displayed in camera-specific display field 67. Frame image 131 is displayed with different display colors depending on the situation.

For example, in a case where the operation of changing confirmation image 101 is performed on the timeline screen (see FIG. 9) in the confirmation state, that is, in a case where candidate display button 102 of confirmation image 101 with an error is operated, red frame image 131 is displayed in camera-specific display field 67 of the confirmed latest camera. In a case where the operation of adding confirmation image 101 is performed on the timeline screen in the confirmation state, that is, in a case where image addition icon 121 of image display frame 107 in a blank state is operated, blue frame image 131 is displayed in camera-specific display field 67 of the confirmed latest camera. Yellow frame image 131 is displayed in camera-specific display field 67 of camera 1 in the cooperation relationship with the confirmed latest camera.

As shown in FIG. 16, the person search screen of the additional designation state in the camera-specific list mode is substantially the same as the person search screen (see FIG. 7) in the initial designation state, but frame image 132 is displayed in camera image 71. With respect to frame image 132, similar to the person search screen (see FIG. 15) in the person-specific list mode, frame image 132 is displayed with different display colors for the confirmed latest camera which is reference and the camera in the cooperation relationship with the confirmed latest camera. Frame image 132 is displayed with different display colors for the confirmed latest camera, in the case of performing the operation of changing confirmation image 101 and the case of performing the operation of adding confirmation image 101.

On the person search screen in the additional designation state, as the initial state, thumbnail image 65 or camera image 71 of the period corresponding to confirmation image 101 with an error and the period corresponding to missing confirmation image 101 is displayed, but it is possible to change the search date and time as needed by using search date and time designation portion 41. On the person search screen in the additional designation state, camera 1 in the cooperation relationship with the confirmed latest camera and the confirmed latest camera are preferentially displayed as the initial state, but by search camera designation unit 42, it is possible to increase or decrease the number of cameras 1 to be searched as needed.

As described above, the exemplary embodiment has been described as an example of the technique disclosed in the present application. However, the technique of the present disclosure is not limited to this, and can also be applied to exemplary embodiments in which change, substitution, addition, omission, or the like is performed. In addition, it is also possible to combine each component described in the above exemplary embodiment to provide a new exemplary embodiment.

For example, in the above exemplary embodiment, an example of a retail store such as a supermarket has been described. However, the present invention can be applied to stores of a business type other than the retail store, such as a restaurant such as a family restaurant, and can also be applied to facilities such as business places other than stores.

In the above exemplary embodiment, an example in which a person is tracked as a moving object has been described, but it is also possible to trace a moving object other than a person, for example, a vehicle such as an automobile or a bicycle.

In the above exemplary embodiment, as shown in FIGS. 1 and 3, an example has been described in which in-camera tracking processing device 4 performs the in-camera tracking process, and PC 3 performs the inter-camera tracking process and a tracking assistance process, but it is also possible to make PC 3 perform the in-camera tracking process. An in-camera tracking processing unit can be provided in camera 1. All or part of intercamera tracking processing unit 22 can be configured with a tracking processing device different from PC 3.

In the above exemplary embodiment, as shown in FIG. 2, the cameras 1 are box-type cameras whose viewing angle is limited. However, the present invention is not limited to this, but an omnidirectional camera capable of imaging a wide range can also be used.

In the present exemplary embodiment, the in-camera tracking process and the tracking assistance process are performed by the device installed in the store, but as shown in FIG. 1, these necessary processes may be performed by PC 11 provided in the head office, or cloud computer 12 constituting the cloud computing system. The necessary processes may be shared by a plurality of information processing apparatuses, and information may be transferred between the plurality of information processing apparatuses through a communication medium such as an internet protocol (IP) network or a local area network (LAN), or a storage medium such as a hard disk or a memory card. In this case, the tracking assistance system is configured with the plurality of information processing apparatuses that share necessary processes.

Particularly, in the system configuration including cloud computer 12, in addition to PCs 3 and 11 provided at the stores and head offices, necessary information may be displayed in portable terminal 13 such as a smartphone or a tablet terminal which is network-connected to cloud computer 12, such that necessary information can be confirmed at any place such as a place to go outside in addition to store and head offices.

In the above exemplary embodiment, recorder 2 that accumulates the captured images from camera 1 is installed in the store, but when the processes necessary for the tracking assistance are performed by PC 11 or cloud computer 12 installed in head office, the captured images from camera 1 may be transmitted to the head office or the management facility of the cloud computing system, and the captured images from camera 1 may be accumulated in the device installed therein.

### INDUSTRIAL APPLICABILITY

The tracking assistance device, the tracking assistance system, and the tracking assistance method according to the present disclosure have an effect capable of efficiently checking whether there is an error in a tracking result for a moving object set as a tracking target, and correcting tracking information with a simple operation, in a case where there is an error in the tracking result for the moving object, in particular, in which the monitoring person can efficiently perform the work for finding an image capturing the moving object which is the tracking target, a tracking assistance system, and a tracking assistance method which displays on a display device, a captured image from each of a plurality of cameras, which is accumulated in image accumulation means, and assists a monitoring person's work for tracking a moving object to be tracked.

### REFERENCE MARKS IN THE DRAWINGS

1 CAMERA
2 RECORDER (IMAGE ACCUMULATION MEANS)
3 PC (TRACKING ASSISTANCE DEVICE)
4 IN-CAMERA TRACKING PROCESSING DEVICE
6 INPUT DEVICE
7 MONITOR
11 PC
12 CLOUD COMPUTER
13 PORTABLE TERMINAL
21 TRACKING INFORMATION ACCUMULATION UNIT
26 FEATURE REFINER
27 THUMBNAIL GENERATOR
28 IMAGE PLAYER
29 SCREEN GENERATOR
32 TRACKING TARGET SETTER
33 ADDITIONAL TRACKING TARGET SETTER
35 LINK SCORE CALCULATOR (EVALUATION VALUE CALCULATOR)
36 INITIAL TRACKING INFORMATION GENERATOR
37 CANDIDATE SELECTOR
38 TRACKING INFORMATION CORRECTOR
39 CONFIRMATION IMAGE PRESENTER
40 CANDIDATE IMAGE PRESENTER

1. A tracking assistance device that displays on a display device, a captured image from each of a plurality of cameras, which is accumulated in image accumulation means, and assists a monitoring person's work of tracking a moving object to be tracked, comprising:
an evaluation value calculator that calculates an evaluation value representing a level of identity between moving objects, based on tracking information of the moving objects detected from the captured image from each of the plurality of cameras;
a tracking target setter that displays a plurality of the captured images on the display device, and in response to an operation input by the monitoring person designating a moving object to be tracked by using the captured images, sets the designated moving object as a tracking target;
a confirmation image presenter that sequentially specifies a camera to take over imaging of the moving object set as the tracking target, by repeating a process of selecting a moving object with a highest evaluation value, from among moving objects detected from captured images of the cameras which are in a cooperation relationship, and displays, on the display device, a tracking target confirmation screen on which a captured image of the moving object with the highest evaluation value is displayed as a confirmation image, for each of the cameras;
a thumbnail generator that cuts out areas of the moving objects from the captured images and generates a thumbnail image of each of the moving objects;
a candidate image presenter that in a case where there is an error in the confirmation image displayed on the tracking target confirmation screen, displays on the display device, a candidate selection screen on which the thumbnail images of respective moving objects having evaluation values lower than the moving object corresponding to the confirmation image are listed and displayed as a candidate image, and allows the monitoring person to select the candidate image corresponding to the moving object designated as the tracking target; and
a tracking information corrector that corrects inter-camera tracking information such that a moving object corresponding to the candidate image selected on the candidate selection screen is associated with the moving object set as the tracking target.

2. A tracking assistance device that displays on a display device, a captured image from each of a plurality of cameras, which is accumulated in image accumulation means, and assists a monitoring person's work of tracking a moving object to be tracked, comprising:
an evaluation value calculator that calculates an evaluation value representing a level of identity between moving objects, based on tracking information of the moving objects detected from the captured image from each of the plurality of cameras;
a thumbnail generator that cuts out areas of the moving objects from the captured images and generates a thumbnail image of each of the moving objects;
a tracking target setter that displays on the display device, a tracking target search screen on which thumbnail images of respective moving objects are displayed as a list, and in response to an operation input by a monitoring person of designating a moving object to be tracked by selecting the thumbnail image, sets the designated moving object as a tracking target;
a confirmation image presenter that sequentially specifies a camera to take over imaging of the moving object set as the tracking target, by repeating a process of selecting a moving object with a highest evaluation value, from among moving objects detected from captured images of the cameras which are in a cooperation relationship, and displays, on the display device, a tracking target confirmation screen on which a captured image of the moving object with the highest evaluation value is displayed as a confirmation image, for each of the cameras;
a candidate image presenter that in a case where there is an error in the confirmation image displayed on the tracking target confirmation screen, displays on the display device, a candidate selection screen on which candidate images of respective moving objects having evaluation values lower than the moving object corresponding to the confirmation image are displayed, and allows the monitoring person to select the candidate image corresponding to the moving object designated as the tracking target; and
a tracking information corrector that corrects inter-camera tracking information such that a moving object corresponding to the candidate image selected on the candidate selection screen is associated with the moving object set as the tracking target.

3. The tracking assistance device of claim 2,
wherein the tracking target setter arranges the thumbnail images in time series, and displays the thumbnail images as a list, on the tracking target search screen.

4. The tracking assistance device of claim 1, further comprising:
an image player that thins out and plays back the selected thumbnail image, in response to an operation input of a monitoring person selecting the thumbnail image.

5. The tracking assistance device of claim 2, further comprising:
an additional tracking target setter that in a case where there is no candidate image corresponding to the moving object designated as the tracking target, among the candidate images displayed on the candidate selection screen, displays on the display device, the tracking target search screen on which thumbnail images of respective moving objects are displayed as a list, and in response to an operation input of the monitoring person designating a moving object to be tracked by selection of the thumbnail image, sets the designated moving object as an additional tracking target,
wherein the tracking information corrector corrects the inter-camera tracking information such that the moving object which is set as the additional tracking target by the additional tracking target setter is associated with the moving object which is set as the tracking target by the tracking target setter.

6. The tracking assistance device of claim 2,
wherein the tracking target setter displays either a moving object-specific image list for displaying the thumbnail images for respective moving objects as a list, or a camera-specific image list for displaying the captured images from respective cameras as a list, on the tracking target search screen, in response to an operation input of a monitoring person selecting a display mode.

7. The tracking assistance device of claim 1, further comprising:
a feature refiner that refines a moving object to be a candidate, based on feature information of the moving object to be tracked,
wherein the candidate image presenter displays the thumbnail image of the moving object refined by the feature refiner, on the candidate selection screen.

8. The tracking assistance device of claim 2, further comprising:
a feature refiner that refines a moving object to be searched, based on feature information of the moving object to be tracked,
wherein the tracking target setter displays the thumbnail image of the moving object refined by the feature refiner, on the tracking target search screen.

9. A tracking assistance system that displays on a display device, a captured image from each of a plurality of cameras, which is accumulated in image accumulation means, and assists a monitoring person's work of tracking a moving object to be tracked, comprising:
the cameras that each captures an image of a monitoring area;
the display device that displays a captured image from each of the cameras; and
a plurality of information processing apparatuses,
wherein any one of the plurality of information processing apparatuses includes
an evaluation value calculator that calculates an evaluation value representing a level of identity between moving objects, based on tracking information of the moving objects detected from the captured image from each of the plurality of cameras;
a tracking target setter that displays a plurality of the captured images on the display device, and in response to an operation input by the monitoring person designating a moving object to be tracked by using the captured images, sets the designated moving object as a tracking target;
a confirmation image presenter that sequentially specifies a camera to take over imaging of the moving object set as the tracking target, by repeating a process of selecting a moving object with a highest evaluation value, from among moving objects detected from captured images of the cameras which are in a cooperation relationship, and displays, on the display device, a tracking target confirmation screen on which a captured image of the moving object with the highest evaluation value is displayed as a confirmation image, for each of the cameras;
a thumbnail generator that cuts out areas of the moving objects from the captured images and generates a thumbnail image of each of the moving objects;
a candidate image presenter that in a case where there is an error in the confirmation image displayed on the tracking target confirmation screen, displays on the display device, a candidate selection screen on which the thumbnail images of respective moving objects having evaluation values lower than the moving object corresponding to the confirmation image are listed and displayed as a candidate image, and allows the monitoring person to select the candidate image corresponding to the moving object designated as the tracking target; and
a tracking information corrector that corrects inter-camera tracking information such that a moving object corresponding to the candidate image selected on the candidate selection screen is associated with the moving object set as the tracking target.

10. A tracking assistance system that displays on a display device, a captured image from each of a plurality of cameras, which is accumulated in image accumulation means, and assists a monitoring person's work of tracking a moving object to be tracked, comprising:
the cameras that each captures an image of a monitoring area;
the display device that displays a captured image from each of the cameras; and
a plurality of information processing apparatuses,
wherein any one of the plurality of information processing apparatuses includes
an evaluation value calculator that calculates an evaluation value representing a level of identity between moving objects, based on tracking information of the moving objects detected from the captured image from each of the plurality of cameras;
a thumbnail generator that cuts out areas of the moving objects from the captured images and generates a thumbnail image of each of the moving objects;
a tracking target setter that displays on the display device, a tracking target search screen in which thumbnail images of respective moving objects are displayed as a list, and in response to an operation input by a monitoring person of designating a moving object to be tracked by selecting the thumbnail image, sets the designated moving object as a tracking target;
a confirmation image presenter that sequentially specifies a camera to take over imaging of the moving object set as the tracking target, by repeating a process of selecting a moving object with a highest evaluation value, from among moving objects detected from captured images of the cameras which are in a cooperation relationship, and displays, on the display device, a tracking target confirmation screen on which a captured image of the moving object with the highest evaluation value is displayed as a confirmation image, for each of the cameras;
a candidate image presenter that in a case where there is an error in the confirmation image displayed on the tracking target confirmation screen, displays on the display device, a candidate selection screen on which candidate images of respective moving objects having evaluation values lower than the moving object corresponding to the confirmation image are displayed, and allows the monitoring person to select the candidate image corresponding to the moving object designated as the tracking target; and
a tracking information corrector that corrects inter-camera tracking information such that a moving object corresponding to the candidate image selected on the candidate selection screen is associated with the moving object set as the tracking target.

11. A tracking assistance method for causing an information processing apparatus to perform a process of displaying on a display device, a captured image from each of a plurality of cameras, which is accumulated in image accumulation means, and assisting a monitoring person's work of tracking a moving object to be tracked, comprising:
calculating an evaluation value representing a level of identity between moving objects, based on tracking information of the moving objects detected from the captured image from each of the plurality of cameras;
displaying a plurality of the captured images on the display device, and in response to an operation input by the monitoring person designating a moving object to be tracked by using the captured images, setting the designated moving object as a tracking target;
sequentially specifying a camera to take over imaging of the moving object set as the tracking target, by repeating a process of selecting a moving object with a highest evaluation value, from among moving objects detected from captured images of the cameras which are in a cooperation relationship, and displaying, on the display device, a tracking target confirmation screen on which a captured image of the moving object with the highest evaluation value is displayed as a confirmation image, for each of the cameras;
cutting out an area of the moving object from the captured image and generating a thumbnail image of each of the moving objects;
in a case where there is an error in the confirmation image displayed on the tracking target confirmation screen, displaying on the display device, a candidate selection screen on which the thumbnail images of respective moving objects having evaluation values lower than the moving object corresponding to the confirmation image are listed and displayed as a candidate image, and allowing the monitoring person to select the candidate image corresponding to the moving object designated as the tracking target; and
correcting inter-camera tracking information such that a moving object corresponding to the candidate image selected on the candidate selection screen is associated with the moving object set as the tracking target.

12. A tracking assistance method for causing an information processing apparatus to perform a process of displaying on a display device, a captured image from each of a plurality of cameras, which is accumulated in image accumulation means, and assisting a monitoring person's work of tracking a moving object to be tracked, comprising:
calculating an evaluation value representing a level of identity between moving objects, based on tracking information of the moving objects detected from the captured image from each of the plurality of cameras;
cutting out an area of the moving object from the captured image and generating a thumbnail image of each of the moving objects;
displaying on the display device, a tracking target search screen on which thumbnail images of respective moving objects are displayed as a list, and in response to an operation input by a monitoring person of designating a moving object to be tracked by selecting the thumbnail image, setting the designated moving object as a tracking target;
sequentially specifying a camera to take over imaging of the moving object set as the tracking target, by repeating a process of selecting a moving object with a highest evaluation value, from among moving objects detected from captured images of the cameras which are in a cooperation relationship, and displaying, on the display device, a tracking target confirmation screen on which a captured image of the moving object with the highest evaluation value is displayed as a confirmation image, for each of the cameras;
in a case where there is an error in the confirmation image displayed on the tracking target confirmation screen, displaying on the display device, a candidate selection screen on which candidate images of respective moving objects having evaluation values lower than the moving object corresponding to the confirmation image are displayed, and allowing the monitoring person to select the candidate image corresponding to the moving object designated as the tracking target; and
correcting inter-camera tracking information such that a moving object corresponding to the candidate image selected on the candidate selection screen is associated with the moving object set as the tracking target.
